(19) United States
(12) Patent Application Publication
(10) Pub. No.: US 2021/0203397 A1
(43) Pub. Date: Jul. 1, 2021

(54) SYSTEMS AND METHODS FOR MULTIPLE-BEAM UPLINK TRANSMISSION

(71) Applicant: Intel Corporation, Santa Clara, CA (US)

(72) Inventors: Gang Xiong, Portland, OR (US); Bishwarup Mondal, San Ramon, CA (US); Guotong Wang, Beijing (CN)

(21) Appl. No.: 17/175,314

(22) Filed: Feb. 12, 2021

Related U.S. Application Data
(60) Provisional application No. 62/976,268, filed on Feb. 13, 2020.
(60) Provisional application No. 63/040,688, filed on Jun. 18, 2020.
(60) Provisional application No. 63/060,852, filed on Aug. 4, 2020.

(51) Int. Cl. H04B 7/06; H04W 72/04; H04W 72/12

(52) U.S. Cl. CPC H04B 7/0695; H04W 72/1289; H04W 72/046; H04W 72/0413

(57) ABSTRACT

Various embodiments herein provide techniques for multiple-beam uplink transmission in a wireless cellular network. For example, a user equipment (UE) may transmit an uplink signal (e.g., a physical uplink shared channel (PUSCH) or a physical uplink control channel (PUCCH)) according to a transmit beam cycling pattern. The transmit beam cycling pattern may be configured or predefined. Other embodiments may be described and claimed.

### CROSS REFERENCE TO RELATED APPLICATION

The present application claims priority to U.S. Provisional Patent Application No. 62/976,268, which was filed Feb. 13, 2020; U.S. Provisional Patent Application No. 63/040,688, which was filed Jun. 18, 2020; and U.S. Provisional Patent Application No. 63/060,852, which was filed Aug. 4, 2020; the disclosures of which are hereby incorporated by reference.

### FIELD

Embodiments relate generally to the technical field of wireless communications.

### BACKGROUND

Mobile communication has evolved significantly from early voice systems to today's highly sophisticated integrated communication platform. The next generation wireless communication system, 5G, or new radio (NR) will provide access to information and sharing of data anywhere, anytime by various users and applications. NR is expected to be a unified network/system that target to meet vastly different and sometime conflicting performance dimensions and services. Such diverse multi-dimensional requirements are driven by different services and applications. In general, NR will evolve based on 3GPP Long Term Evolution (LTE)-Advanced with additional potential new Radio Access Technologies (RATs) to enrich people lives with better, simple and seamless wireless connectivity solutions. NR will enable everything connected by wireless and deliver fast, rich contents and services.

For 5G system, high frequency band communication has attracted significantly attention from the industry, since it can provide wider bandwidth to support the future integrated communication system. The beam forming is a critical technology for the implementation of high frequency band system due to the fact that the beam forming gain can compensate the severe path loss caused by atmospheric attenuation, improve the signal-to-noise ratio (SNR), and enlarge the coverage area. By aligning the transmission beam to the target UE, radiated energy is focused for higher energy efficiency, and mutual UE interference is suppressed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example beam cycling pattern for a physical uplink shared channel (PUSCH) and/or physical uplink control channel (PUCCH), in accordance with various embodiments.

FIG. 2 illustrates another example beam cycling pattern for a PUSCH and/or PUCCH, in accordance with various embodiments.

FIG. 3 illustrates another example beam cycling pattern for a PUSCH and/or PUCCH, in accordance with various embodiments.

FIG. 4 illustrates an example beam cycling pattern in case of cancellation of an uplink transmission with repetition, in accordance with various embodiments.

FIG. 5 illustrates another example beam cycling pattern in case of cancellation of an uplink transmission with repetition, in accordance with various embodiments.

FIG. 6 illustrates an example of applying a beam cycling pattern to a nominal PUSCH repetition, in accordance with various embodiments.

Example 7 illustrates an example of applying a beam cycling pattern to an actual PUSCH repetition, in accordance with various embodiments.

FIG. 8 illustrates a medium access control (MAC) control element (CE) for activation and/or deactivation of PUCCH spatial relation information, in accordance with various embodiments.

FIG. 9 schematically illustrates a wireless network in accordance with various embodiments.

FIG. 10 schematically illustrates components of a wireless network in accordance with various embodiments.

FIG. 11 is a block diagram illustrating components, according to some example embodiments, able to read instructions from a machine-readable or computer-readable medium (e.g., a non-transitory machine-readable storage medium) and perform any one or more of the methodologies discussed herein.

FIG. 12 is a flowchart of an example process that may be performed by a user equipment (UE), in accordance with various embodiments.

FIG. 13 is a flowchart of an example process that may be performed by a next generation Node B (gNB), in accordance with various embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

In NR Rel-15, number of repetitions can be configured for the transmission of physical uplink shared channel (PUSCH) and physical uplink control channel (PUCCH). When repetition is employed, same time domain resource allocation (TDRA) for the transmission of PUCCH and PUSCH is used in each slot. Further, inter-slot frequency hopping can be configured to improve the performance by exploiting frequency diversity. In Rel-16, the number of repetitions for PUSCH can be dynamically indicated in the downlink control information (DCI).

For frequency range 2, cellular communication system is vulnerable to blockages due to higher penetration losses and reduced diffraction. More specifically, in case when the communication link between a next generation Node B (gNB) and a user equipment (UE) is blocked by an object, signal to noise ratio (SNR) can be largely reduced and hence substantial performance degradation is expected. To reduce the blockage and further improve the coverage for frequency range 2, certain mechanisms may need to be considered in conjunction with repetition for the transmission of PUSCH and PUCCH.

Various embodiments herein provide techniques for multiple-beam based uplink transmission. For example, embodiments include:

Beam cycling pattern for multiple-beam based uplink transmission;

Multiple-beam based PUSCH transmission; and/or

Multiple-beam based PUCCH transmission.

Beam Cycling Pattern for Multiple-Beam Based Uplink Transmission

As mentioned above, for frequency range 2, cellular communication system is vulnerable to blockages due to higher penetration losses and reduced diffraction. More specifically, in case when the communication link between gNB and UE is blocked by an object, signal to noise ratio (SNR) can be largely reduced and hence substantial performance degradation is expected. To reduce the blockage and further improve the coverage for frequency range 2, certain mechanisms may need to be considered in conjunction with repetition for the transmission of PUSCH and PUCCH.

Embodiments of multiple-beam based uplink transmission are provided as follows:

In one embodiment, to further improve the performance of PUSCH and/or PUCCH, beam sweeping can be employed in conjunction with repetition for the transmission of PUSCH and/or PUCCH. In particular, a first Tx beam can be applied for a first part of PUSCH and/or PUCCH repetition and a second Tx beam can be applied for a second part of PUSCH and/or PUCCH repetition.

Further, a beam cycling pattern may be defined when uplink transmission with repetition is employed. UE transmits the PUSCH and/or PUCCH with repetition using the Tx beam in accordance with the beam cycling pattern.

Note that the multiple beam based transmission may be applied for the repetition of, for example:
Dynamic grant PUSCH transmission, where PUSCH is scheduled by a downlink control information (DCI);
Configured grant PUSCH transmission, including both Type 1 and Type 2 configured grant PUSCH; and/or
PUCCH carrying scheduling request (SR), channel state information (CSI) report and/or hybrid automatic repeat request-acknowledgement (HARQ-ACK) feedback.

In another embodiment, an interleaved pattern may be defined for the beam cycling pattern. In particular, a first Tx beam is applied for the first PUSCH and/or PUCCH transmission occasion or the first slot within the repetition and a second Tx beam is applied for the first PUSCH and/or PUCCH transmission occasion or the first slot within the repetition. Further, the Tx beam pattern is repeated across the PUSCH and/or PUCCH with repetition.

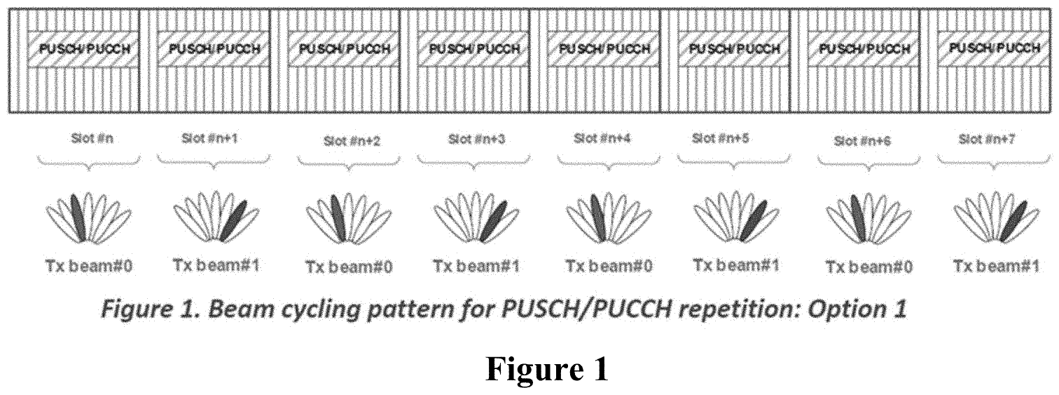

FIG. 1 illustrates one example of beam cycling pattern for this option. In the example, it is assumed 8 repetitions are applied for the transmission of PUSCH/PUCCH. Same time domain resource allocation is applied in each slot for the repetition. In this case, Tx beam #0 is applied for the repetition with slot index #n, n+2, n+4, n+6 while Tx beam #1 is applied for the repetition with slot index #n+1, n+3, n+5, n+7.

In another embodiment, the beam cycling pattern may be defined such that the first Tx beam is applied for the first N PUSCH and/or PUCCH transmission occasions or the first N slot within the repetition and a second Tx beam is applied for the first N PUSCH and/or PUCCH transmission occasions or the first N slots within the repetition. Further, the Tx beam pattern is repeated across the PUSCH and/or PUCCH with repetition. Note that N can be predefined in the specification, e.g., N=2, or 4, or configured by higher layer via NR remaining minimum system information (RMSI), NR other system information (OSI) or dedicated radio resource control (RRC) signaling or dynamically indicated in the DCI or a combination thereof.

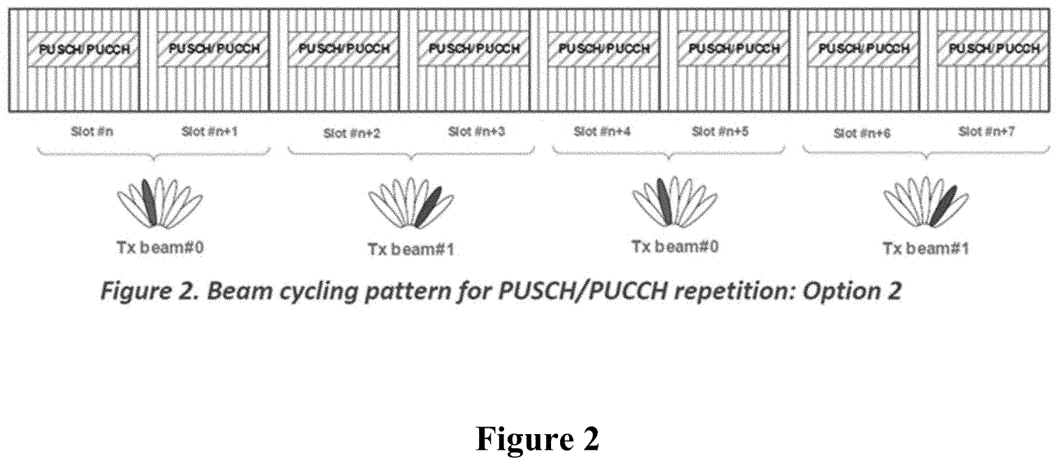

FIG. 2 illustrates one example of beam cycling pattern for this option. In the example, it is assumed 8 repetitions are applied for the transmission of PUSCH/PUCCH. Further, N=2 is applied for the beam cycling pattern. In this case, Tx beam #0 is applied for the repetition with slot index #n, n+1, n+4, n+5 while Tx beam #1 is applied for the repetition with slot index #n+2, n+3, n+6, n+7.

As a further extension, N may be determined in accordance with the number of repetitions for the transmission of PUSCH and/or PUCCH. In particular,

$$N = ⌊ \frac{{K}_{R e p}}{2} ⌋ or N = ⌈ \frac{{K}_{R e p}}{2} ⌉$$

In this case, the beam cycling pattern may be defined such that the first Tx beam is applied for the first half of the repetition and the second Tx beam is applied for the second half of the repetition for uplink transmission.

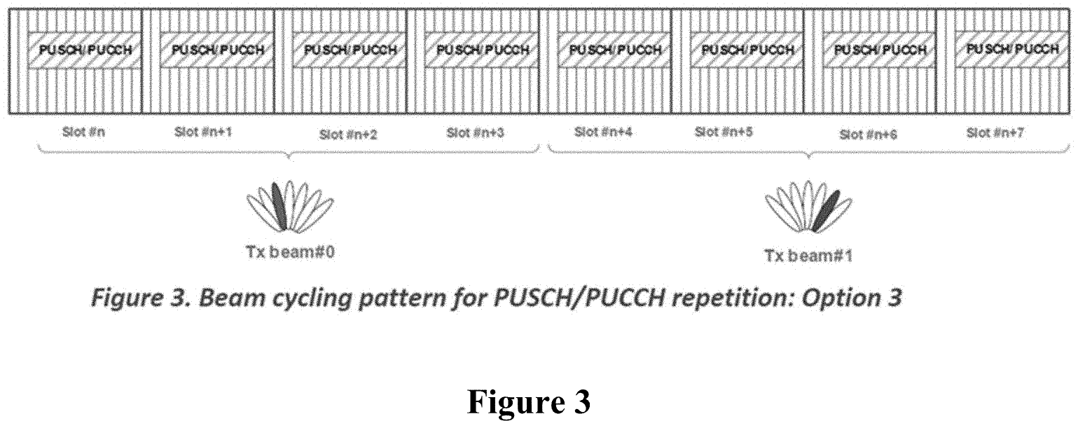

FIG. 3 illustrates one example of beam cycling pattern for this option. In the example, it is assumed 8 repetitions are applied for the transmission of PUSCH/PUCCH. Further, Tx beam #0 is applied for the first half of the repetition and Tx beam #1 is applied for the second half of the repetition.

In another embodiment, beam cycling pattern may be defined such that the number of uplink transmission occasions or slots for one Tx beam can be aligned with the number uplink transmission occasions or slots where same frequency resource is allocated for uplink transmission with repetition.

For instance, in case of frequency hopping, UE may perform frequency hopping every D slots or transmission occasions. For this option, beam cycling may align with the frequency hopping pattern, such that UE may switch Tx beams for uplink transmission every D slots or transmission occasions, where D may be predefined in the specification or RMSI (SIB1), OSI or RRC signaling or dynamically indicated in the DCI or a combination thereof.

In another embodiment, in case when a repetition or transmission occasion of the uplink transmission is canceled during the repetition, e.g., due to overlapping of other physical channels or semi-static TDD DL/UL configuration, the Tx beam cycling pattern is continued regardless of whether one uplink repetition or transmission occasion is dropped.

Note that this option may be applied for the PUSCH repetition type A.

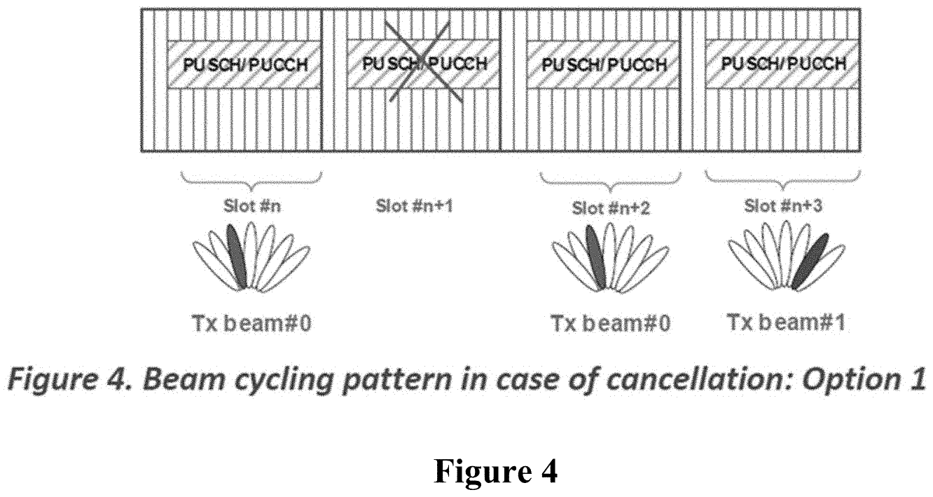

FIG. 4 illustrates one example of beam cycling pattern in case of cancellation of uplink transmission with repetition. In the example, PUSCH/PUCCH transmission in the slot #n+1 is dropped. Further, Tx beam is cycled in an alternative manner. Based on the aforementioned beam cycling pattern in case of cancellation, UE will follow the beam pattern without considering the cancellation of uplink transmission. In this case, UE applies Tx beam #0 in slot #n and #n+2 and Tx beam #1 in slot #3.

Yet in another option, when a repetition or transmission occasion of the uplink transmission is canceled during the repetition, the Tx beam cycling pattern is resumed after the cancellation. Note that this option may be applied for the PUSCH repetition type A.

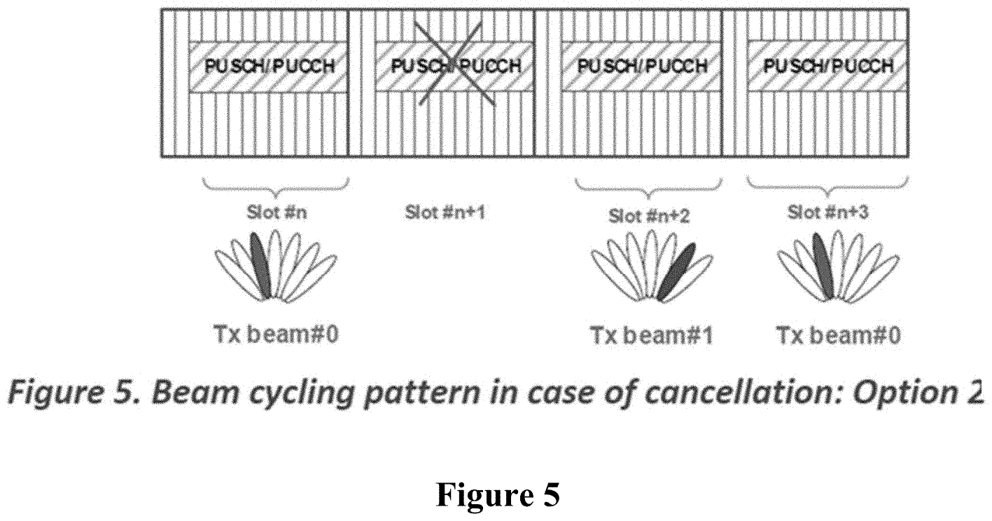

FIG. 5 illustrates one example of beam cycling pattern in case of cancellation of uplink transmission with repetition. In the example, PUSCH/PUCCH transmission in the slot #n+1 is dropped. Further, Tx beam is cycled in an alternative manner. Based on the aforementioned beam cycling pattern in case of cancellation, UE will resume the beam cycling pattern in slot #n+2. In this case, UE applies Tx beam #0 in slot #n and #n+3 and Tx beam #1 in slot #2.

Multiple-Beam Based PUSCH Transmission

Embodiments of multiple beam based PUSCH transmission are provided as follows:

In another embodiment, a single downlink control information (DCI), e.g., DCI format 0_1 or 0_2, can be used to schedule the PUSCH repetition with beam sweeping operation. Note that this can be applied for the dynamical grant PUSCH transmission and activation/release of Type 2 configured grant PUSCH.

In one option, SRS resource indicator in the DCI can be used to indicate the multiple Tx beams used for the transmission of PUSCH with repetition. In particular, one codepoint for SRS resource indicator may be pointed to multiple SRS resources which are associated with different Tx beams or SRS-SpatialRelationInfo. When two SRS resources with different SRS-SpatialRelationInfo are configured for one codepoint in SRS resource indicator, this indicates that two Tx beams are used for dynamic grant PUSCH transmission.

Note that this option can also be used to dynamically switch between multiple beam and single beam based PUSCH transmission. For instance, one codepoint for SRS resource indicator may be pointed to one SRS resource while another codepoint for SRS resource indicator may be pointed to multiple SRS resources with different spatial relation or Tx beams.

In another embodiment, within a SRS resource, multiple SRS-SpatialRelationInfo may be configured to allow the multiple beam transmission for the PUSCH transmission.

In one example, the following RRC parameter can be updated with the underlined portion to include more than one reference signal for SRS spatial relation.

| SRS-SpatialRelationInfo ::= | | SEQUENCE { | |
|---|---|---|---|
| | servingCellId | ServCellIndex | OPTIONAL, -- Need S |

| | |
|---|---|
| referenceSignal | CHOICE { |

| | |
|---|---|
| ssb-Index | SSB-Index, |
| csi-RS-Index | NZP-CSI-RS-ResourceId, |

| | |
|---|---|
| srs | SEQUENCE { |

| | |
|---|---|
| resourceId | SRS-ResourceId, |
| uplinkBWP | BWP-Id |

}

| | |
|---|---|
| referenceSignaladditional | CHOICE { |

| | |
|---|---|
| ssb-Index | SSB-Index, |
| csi-RS-Index | NZP-CSI-RS-ResourceId, |

| | |
|---|---|
| srs | SEQUENCE { |

| resourceId | SRS-ResourceId, |
|---|---|
| uplinkBWP | BWP-Id |

}

}

}

In another example, more than one ssb-Index, csi-RS-Index, or srs in referenceSignal can be configured for SRS-SpatialRelationInfo for multiple beam PUSCH transmission.

In another embodiment, for configured grant PUSCH transmission, the above option can be applied. For instance, multiple SRS-SpatialRelationInfo can be configured or ssb-Index, csi-RS-Index, or srs can be configured to enable multiple beam based PUSCH transmission.

In another option, multiple srs-ResourceIndicator in rrc-ConfiguredUplinkGrant may be configured to allow configured grant PUSCH transmission with multiple beams.

In another embodiment, when PUSCH is scheduled by DCI format 0_0 or fallback DCI, PUSCH repetition with single Tx beam is employed, where PUSCH spatial relation info is determined based on spatial relation info of PUCCH with lowest resource ID. In case when more than one spatial relation info are configured and selected by MAC CE for PUCCH with lowest resource ID, UE applies the spatial relation info with lowest ID of PUCCH with lowest resource ID for the transmission of PUSCH with repetition.

In another option, when PUSCH is scheduled by DCI format 0_0 or fallback DCI, and when more than one spatial relation info are configured and selected by MAC CE for PUCCH with lowest resource ID, PUSCH repetition with multiple beams is employed.

In another embodiment, for PUSCH repetition type B, beam cycling pattern is applied on the nominal PUSCH repetition. In other words, regardless of whether multiple segments are generated due to conflict with DL symbols, invalid symbols and/or slot boundary, beam cyclic pattern is applied on the PUSCH repetition before handling the collision.

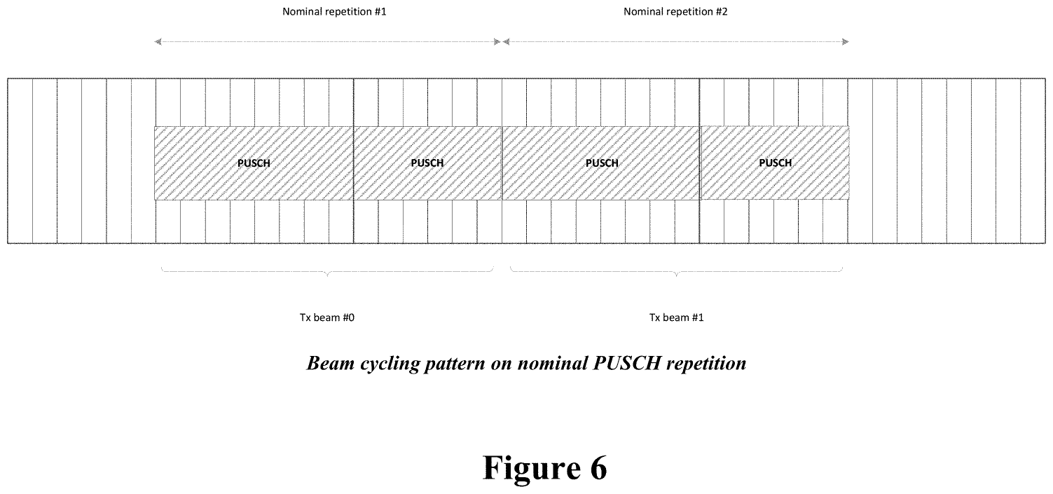

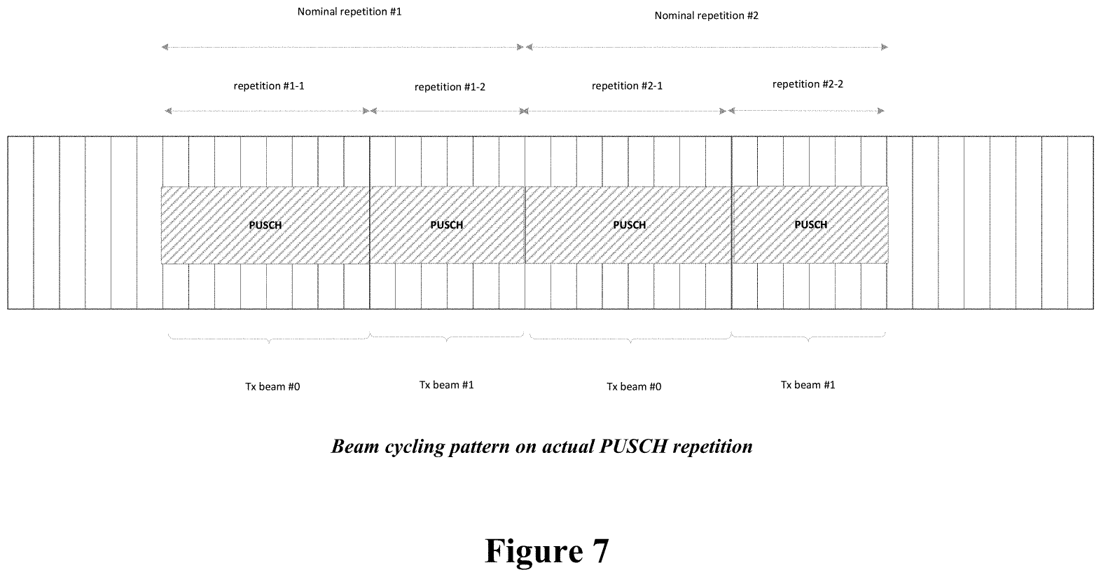

FIG. 6 illustrates one example of applying beam cycling pattern on nominal PUSCH repetition. In the example, it is assumed that starting symbol of first nominal PUSCH repetition is 6 and length of PUSCH repetition is 14 symbols. Further, 2 repetitions are applied for PUSCH transmission. Based on the PUSCH repetition type B, PUSCH repetition is divided into two segments for each repetition due to across slot boundary. Note that beam cyclic pattern is assumed as {Tx beam #0, Tx beam #1, Tx beam #0, Tx beam #1}. For this option, regardless of multiple segments on actual transmission in each repetition, Tx beam #0 is applied on the nominal PUSCH repetition #1 and Tx beam #1 is applied on the nominal repetition #2.

In another embodiment, for PUSCH mapping type B, beam cycling pattern is applied for the actual PUSCH repetition. In other words, beam cyclic pattern is applied on the actual PUSCH repetition after handling the collision with DL symbols, invalid symbols and/or slot boundary.

FIG. 7 illustrates one example of applying beam cycling pattern on actual PUSCH repetition. In the example, it is assumed that starting symbol of first nominal PUSCH repetition is 6 and length of PUSCH repetition is 14 symbols. Further, 2 repetitions are applied for PUSCH transmission. Based on the PUSCH repetition type B, PUSCH repetition is divided into two segments for each repetition due to across slot boundary. In particular, repetition #1-1 and repetition #1-2 are the first and second actual repetition within nominal repetition #1, while repetition #2-1 and repetition #2-2 are the first and second actual repetition within nominal repetition #2.

Note that beam cyclic pattern is assumed as {Tx beam #0, Tx beam #1, Tx beam #0, Tx beam #1}. For this option, beam cyclic pattern is applied on the actual PUSCH repetition. More specifically, Tx beam #0 is applied on the actual PUSCH repetition #1-1 and #2-1 and Tx beam #1 is applied on the actual PUSCH repetition #1-2 and #2-2.

Multiple-Beam Based PUCCH Transmission

Embodiments of multiple-beam based PUCCH transmission are provided as follows:

In one embodiment, in Rel-15, multiple PUCCH-SpatialRelationInfo can be configured for each PUCCH resource. Further, if more than 1 spatial relation info is configured, a medium access control-control element (MAC CE) is used to down-select to one spatial relation info. Note that only one PUCCH Spatial Relation Info can be active for a PUCCH Resource at a time.

For multiple beam based PUCCH transmission, multiple PUCCH-SpatialRelationInfo can be configured for each PUCCH resource. Further, more than PUCCH Spatial Relation Info can be active for a PUCCH Resource at a time. In this case, UE may transmit PUCCH repetition with different Tx beams.

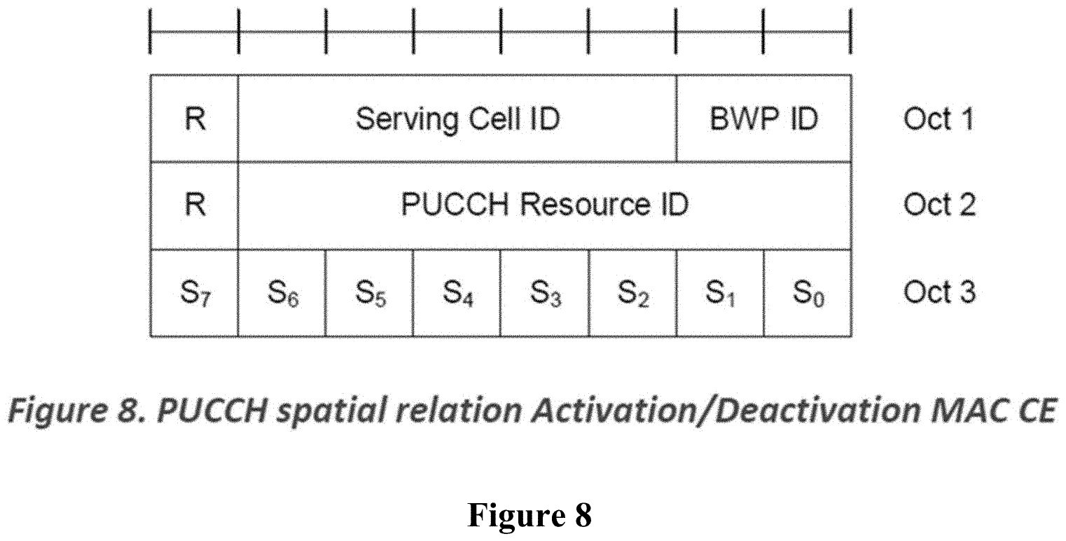

FIG. 8 illustrates a MAC CE for PUCCH spatial relation Activation/Deactivation. For multiple beam based PUCCH transmission, more than one Si can be enabled to active multiple spatial relation info for a PUCCH resource.

Note that spatial relation info with lower ID is used as a first beam for PUCCH transmission while spatial relation info with larger ID is used as a second beam for PUCCH transmission.

In another embodiment, for one PUCCH spatial relation info or PUCCH-SpatialRelationInfo, multiple reference signals can be configured for PUCCH Tx beam. Note that same mechanism can be applied for PUCCH-SpatialRelationInfo-r16.

In one example, the following RRC parameter can be updated with red color to include more than one reference signal for PUCCH-SpatialRelationInfo.

| | |
|---|---|
| PUCCH-SpatialRelationInfo ::= | SEQUENCE { |

| | |
|---|---|
| pucch-SpatialRelationInfoId | PUCCH-SpatialRelationInfoId, |

| | | |
|---|---|---|
| servingCellId | ServCellIndex | OPTIONAL, -- Need S |

| | |
|---|---|
| referenceSignal | CHOICE { |

| | |
|---|---|
| ssb-Index | SSB-Index, |
| csi-RS-Index | NZP-CSI-RS-ResourceId, |

| | |
|---|---|
| srs | PUCCH-SRS |

| } | |
|---|---|
| referenceSignaladditional | CHOICE { |

| | |
|---|---|
| ssb-Index | SSB-Index, |

| | |
|---|---|
| csi-RS-Index | NZP-CSI-RS-ResourceId, |

| | |
|---|---|
| srs | SEQUENCE { |

| | |
|---|---|
| resourceId | SRS-ResourceId, |

| | |
|---|---|
| uplinkBWP | BWP-Id |

}

| , | |
|---|---|
| pucch-PathlossReferenceRS-Id | PUCCH-PathlossReferenceRS-Id, |
| p0-PUCCH-Id | P0-PUCCH-Id, |
| closedLoopIndex | ENUMERATED { i0, i1 } |

}

In another embodiment, more than one ssb-Index, csi-RS-Index, or srs in referenceSignal can be configured for PUCCH-SpatialRelationInfo for multiple beam PUCCH transmission.

In one example, the following RRC parameter can be updated with the underlined portion to include more than one ssb-Index, csi-RS-Index, or srs in referenceSignal for PUCCH-SpatialRelationInfo.

| | |
|---|---|
| PUCCH-SpatialRelationInfo ::= | SEQUENCE { |

| | |
|---|---|
| pucch-SpatialRelationInfoId | PUCCH-SpatialRelationInfoId, |

| | | |
|---|---|---|
| servingCellId | ServCellIndex | OPTIONAL, -- Need S |

| | |
|---|---|
| referenceSignal | CHOICE { |

| | |
|---|---|
| ssb-Index | SSB-Index, |

| | |
|---|---|
| ssb-Indexadditional | SSB-Index, |

| | |
|---|---|
| csi-RS-Index | NZP-CSI-RS-ResourceId, |

| | |
|---|---|
| csi-RS-Indexadditional | NZP-CSI-RS-ResourceId, |

| | |
|---|---|
| srs | PUCCH-SRS |

| | |
|---|---|
| srsadditional | PUCCH-SRS |

}

| | |
|---|---|
| pucch-PathlossReferenceRS-Id | PUCCH-PathlossReferenceRS-Id, |

| | |
|---|---|
| p0-PUCCH-Id | P0-PUCCH-Id, |
| closedLoopIndex | ENUMERATED { i0, i1 } |

}

### Systems and Implementations

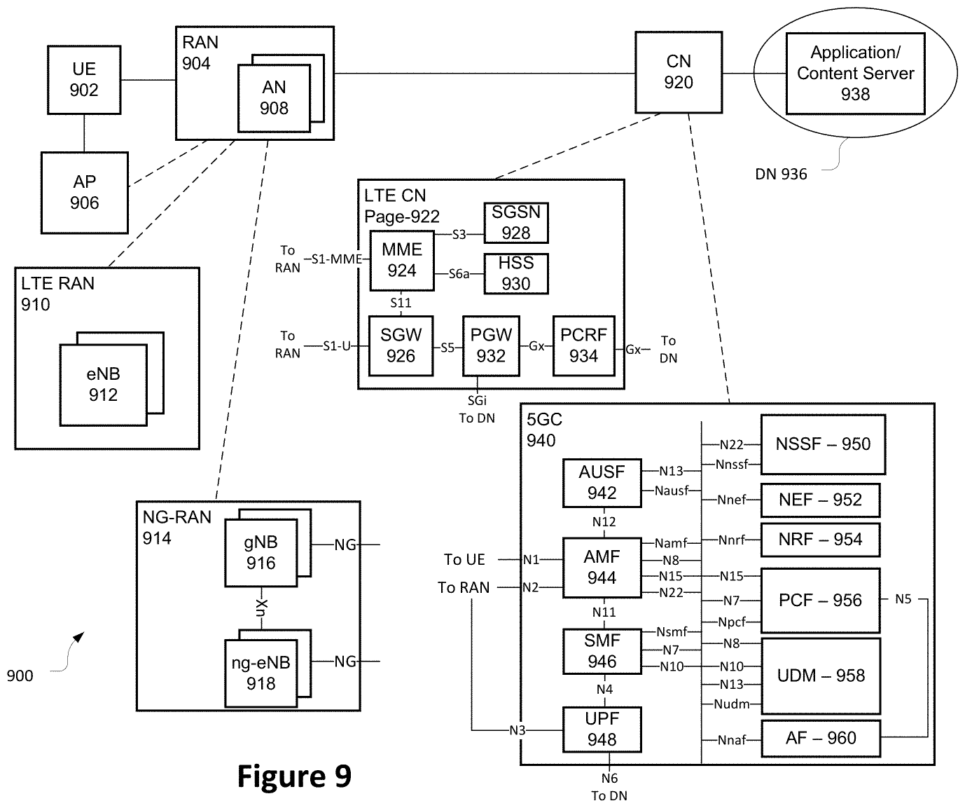

FIGS. 9-11 illustrate various systems, device, and components that may implement aspects of disclosed embodiments.

FIG. 9 illustrates a network 900 in accordance with various embodiments. The network 900 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 900 may include a UE 902, which may include any mobile or non-mobile computing device designed to communicate with a RAN 904 via an over-the-air connection. The UE 902 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 900 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 902 may additionally communicate with an AP 906 via an over-the-air connection. The AP 906 may manage a WLAN connection, which may serve to offload some/all network traffic from the RAN 904. The connection between the UE 902 and the AP 906 may be consistent with any IEEE 802.11 protocol, wherein the AP 906 could be a wireless fidelity (Wi-Fi®) router. In some embodiments, the UE 902, RAN 904, and AP 906 may utilize cellular-WLAN aggregation (for example, LWA/LWIP). Cellular-WLAN aggregation may involve the UE 902 being configured by the RAN 904 to utilize both cellular radio resources and WLAN resources.

The RAN 904 may include one or more access nodes, for example, AN 908. AN 908 may terminate air-interface protocols for the UE 902 by providing access stratum protocols including RRC, PDCP, RLC, MAC, and L1 protocols. In this manner, the AN 908 may enable data/voice connectivity between CN 920 and the UE 902. In some embodiments, the AN 908 may be implemented in a discrete device or as one or more software entities running on server computers as part of, for example, a virtual network, which may be referred to as a CRAN or virtual baseband unit pool. The AN 908 be referred to as a BS, gNB, RAN node, eNB, ng-eNB, NodeB, RSU, TRxP, TRP, etc. The AN 908 may be a macrocell base station or a low power base station for providing femtocells, picocells or other like cells having smaller coverage areas, smaller user capacity, or higher bandwidth compared to macrocells.

In embodiments in which the RAN 904 includes a plurality of ANs, they may be coupled with one another via an X2 interface (if the RAN 904 is an LTE RAN) or an Xn interface (if the RAN 904 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 904 may each manage one or more cells, cell groups, component carriers, etc. to provide the UE 902 with an air interface for network access. The UE 902 may be simultaneously connected with a plurality of cells provided by the same or different ANs of the RAN 904. For example, the UE 902 and RAN 904 may use carrier aggregation to allow the UE 902 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 904 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 902 or AN 908 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 904 may be an LTE RAN 910 with eNBs, for example, eNB 912. The LTE RAN 910 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 904 may be an NG-RAN 914 with gNBs, for example, gNB 916, or ng-eNBs, for example, ng-eNB 918. The gNB 916 may connect with 5G-enabled UEs using a 5G NR interface. The gNB 916 may connect with a 5G core through an NG interface, which may include an N2 interface or an N3 interface. The ng-eNB 918 may also connect with the 5G core through an NG interface, but may connect with a UE via an LTE air interface. The gNB 916 and the ng-eNB 918 may connect with each other over an Xn interface.

In some embodiments, the NG interface may be split into two parts, an NG user plane (NG-U) interface, which carries traffic data between the nodes of the NG-RAN 914 and a UPF 948 (e.g., N3 interface), and an NG control plane (NG-C) interface, which is a signaling interface between the nodes of the NG-RAN 914 and an AMF 944 (e.g., N2 interface).

The NG-RAN 914 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 902 can be configured with multiple BWPs where each BWP configuration has a different SCS. When a BWP change is indicated to the UE 902, the SCS of the transmission is changed as well. Another use case example of BWP is related to power saving. In particular, multiple BWPs can be configured for the UE 902 with different amount of frequency resources (for example, PRBs) to support data transmission under different traffic loading scenarios. A BWP containing a smaller number of PRBs can be used for data transmission with small traffic load while allowing power saving at the UE 902 and in some cases at the gNB 916. A BWP containing a larger number of PRBs can be used for scenarios with higher traffic load.

The RAN 904 is communicatively coupled to CN 920 that includes network elements to provide various functions to support data and telecommunications services to customers/subscribers (for example, users of UE 902). The components of the CN 920 may be implemented in one physical node or separate physical nodes. In some embodiments, NFV may be utilized to virtualize any or all of the functions provided by the network elements of the CN 920 onto physical compute/storage resources in servers, switches, etc. A logical instantiation of the CN 920 may be referred to as a network slice, and a logical instantiation of a portion of the CN 920 may be referred to as a network sub-slice.

In some embodiments, the CN 920 may be an LTE CN 922, which may also be referred to as an EPC. The LTE CN 922 may include MME 924, SGW 926, SGSN 928, HSS 930, PGW 932, and PCRF 934 coupled with one another over interfaces (or “reference points”) as shown. Functions of the elements of the LTE CN 922 may be briefly introduced as follows.

The MME 924 may implement mobility management functions to track a current location of the UE 902 to facilitate paging, bearer activation/deactivation, handovers, gateway selection, authentication, etc.

The SGW 926 may terminate an S1 interface toward the RAN and route data packets between the RAN and the LTE CN 922. The SGW 926 may be a local mobility anchor point for inter-RAN node handovers and also may provide an anchor for inter-3GPP mobility. Other responsibilities may include lawful intercept, charging, and some policy enforcement.

The SGSN 928 may track a location of the UE 902 and perform security functions and access control. In addition, the SGSN 928 may perform inter-EPC node signaling for mobility between different RAT networks; PDN and S-GW selection as specified by MME 924; MME selection for handovers; etc. The S3 reference point between the MME 924 and the SGSN 928 may enable user and bearer information exchange for inter-3GPP access network mobility in idle/active states.

The HSS 930 may include a database for network users, including subscription-related information to support the network entities' handling of communication sessions. The HSS 930 can provide support for routing/roaming, authentication, authorization, naming/addressing resolution, location dependencies, etc. An S6a reference point between the HSS 930 and the MME 924 may enable transfer of subscription and authentication data for authenticating/authorizing user access to the LTE CN 920.

The PGW 932 may terminate an SGi interface toward a data network (DN) 936 that may include an application/content server 938. The PGW 932 may route data packets between the LTE CN 922 and the data network 936. The PGW 932 may be coupled with the SGW 926 by an S5 reference point to facilitate user plane tunneling and tunnel management. The PGW 932 may further include a node for policy enforcement and charging data collection (for example, PCEF). Additionally, the SGi reference point between the PGW 932 and the data network 936 may be an operator external public, a private PDN, or an intra-operator packet data network, for example, for provision of IMS services. The PGW 932 may be coupled with a PCRF 934 via a Gx reference point.

The PCRF 934 is the policy and charging control element of the LTE CN 922. The PCRF 934 may be communicatively coupled to the app/content server 938 to determine appropriate QoS and charging parameters for service flows. The PCRF 932 may provision associated rules into a PCEF (via Gx reference point) with appropriate TFT and QCI.

In some embodiments, the CN 920 may be a 5GC 940. The 5GC 940 may include an AUSF 942, AMF 944, SMF 946, UPF 948, NSSF 950, NEF 952, NRF 954, PCF 956, UDM 958, and AF 960 coupled with one another over interfaces (or “reference points”) as shown. Functions of the elements of the 5GC 940 may be briefly introduced as follows.

The AUSF 942 may store data for authentication of UE 902 and handle authentication-related functionality. The AUSF 942 may facilitate a common authentication framework for various access types. In addition to communicating with other elements of the 5GC 940 over reference points as shown, the AUSF 942 may exhibit an Nausf service-based interface.

The AMF 944 may allow other functions of the 5GC 940 to communicate with the UE 902 and the RAN 904 and to subscribe to notifications about mobility events with respect to the UE 902. The AMF 944 may be responsible for registration management (for example, for registering UE 902), connection management, reachability management, mobility management, lawful interception of AMF-related events, and access authentication and authorization. The AMF 944 may provide transport for SM messages between the UE 902 and the S1VIF 946, and act as a transparent proxy for routing SM messages. AMF 944 may also provide transport for SMS messages between UE 902 and an SMSF. AMF 944 may interact with the AUSF 942 and the UE 902 to perform various security anchor and context management functions. Furthermore, AMF 944 may be a termination point of a RAN CP interface, which may include or be an N2 reference point between the RAN 904 and the AMF 944; and the AMF 944 may be a termination point of NAS (N1) signaling, and perform NAS ciphering and integrity protection. AMF 944 may also support NAS signaling with the UE 902 over an N3 IWF interface.

The SMF 946 may be responsible for SM (for example, session establishment, tunnel management between UPF 948 and AN 908); UE IP address allocation and management (including optional authorization); selection and control of UP function; configuring traffic steering at UPF 948 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 944 over N2 to AN 908; and determining SSC mode of a session. SM may refer to management of a PDU session, and a PDU session or “session” may refer to a PDU connectivity service that provides or enables the exchange of PDUs between the UE 902 and the data network 936.

The UPF 948 may act as an anchor point for intra-RAT and inter-RAT mobility, an external PDU session point of interconnect to data network 936, and a branching point to support multi-homed PDU session. The UPF 948 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 948 may include an uplink classifier to support routing traffic flows to a data network.

The NSSF 950 may select a set of network slice instances serving the UE 902. The NSSF 950 may also determine allowed NSSAI and the mapping to the subscribed S-NSSAIs, if needed. The NSSF 950 may also determine the AMF set to be used to serve the UE 902, or a list of candidate AMFs based on a suitable configuration and possibly by querying the NRF 954. The selection of a set of network slice instances for the UE 902 may be triggered by the AMF 944 with which the UE 902 is registered by interacting with the NSSF 950, which may lead to a change of AMF. The NSSF 950 may interact with the AMF 944 via an N22 reference point; and may communicate with another NSSF in a visited network via an N31 reference point (not shown). Additionally, the NSSF 950 may exhibit an Nnssf service-based interface.

The NEF 952 may securely expose services and capabilities provided by 3GPP network functions for third party, internal exposure/re-exposure, AFs (e.g., AF 960), edge computing or fog computing systems, etc. In such embodiments, the NEF 952 may authenticate, authorize, or throttle the AFs. NEF 952 may also translate information exchanged with the AF 960 and information exchanged with internal network functions. For example, the NEF 952 may translate between an AF-Service-Identifier and an internal 5GC information. NEF 952 may also receive information from other NFs based on exposed capabilities of other NFs. This information may be stored at the NEF 952 as structured data, or at a data storage NF using standardized interfaces. The stored information can then be re-exposed by the NEF 952 to other NFs and AFs, or used for other purposes such as analytics. Additionally, the NEF 952 may exhibit an Nnef service-based interface.

The NRF 954 may support service discovery functions, receive NF discovery requests from NF instances, and provide the information of the discovered NF instances to the NF instances. NRF 954 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 954 may exhibit the Nnrf service-based interface.

The PCF 956 may provide policy rules to control plane functions to enforce them, and may also support unified policy framework to govern network behavior. The PCF 956 may also implement a front end to access subscription information relevant for policy decisions in a UDR of the UDM 958. In addition to communicating with functions over reference points as shown, the PCF 956 exhibit an Npcf service-based interface.

The UDM 958 may handle subscription-related information to support the network entities' handling of communication sessions, and may store subscription data of UE 902. For example, subscription data may be communicated via an N8 reference point between the UDM 958 and the AMF 944. The UDM 958 may include two parts, an application front end and a UDR. The UDR may store subscription data and policy data for the UDM 958 and the PCF 956, and/or structured data for exposure and application data (including PFDs for application detection, application request information for multiple UEs 902) for the NEF 952. The Nudr service-based interface may be exhibited by the UDR 221 to allow the UDM 958, PCF 956, and NEF 952 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 958 may exhibit the Nudm service-based interface.

The AF 960 may provide application influence on traffic routing, provide access to NEF, and interact with the policy framework for policy control.

In some embodiments, the 5GC 940 may enable edge computing by selecting operator/3rd party services to be geographically close to a point that the UE 902 is attached to the network. This may reduce latency and load on the network. To provide edge-computing implementations, the 5GC 940 may select a UPF 948 close to the UE 902 and execute traffic steering from the UPF 948 to data network 936 via the N6 interface. This may be based on the UE subscription data, UE location, and information provided by the AF 960. In this way, the AF 960 may influence UPF (re)selection and traffic routing. Based on operator deployment, when AF 960 is considered to be a trusted entity, the network operator may permit AF 960 to interact directly with relevant NFs. Additionally, the AF 960 may exhibit an Naf service-based interface.

The data network 936 may represent various network operator services, Internet access, or third party services that may be provided by one or more servers including, for example, application/content server 938.

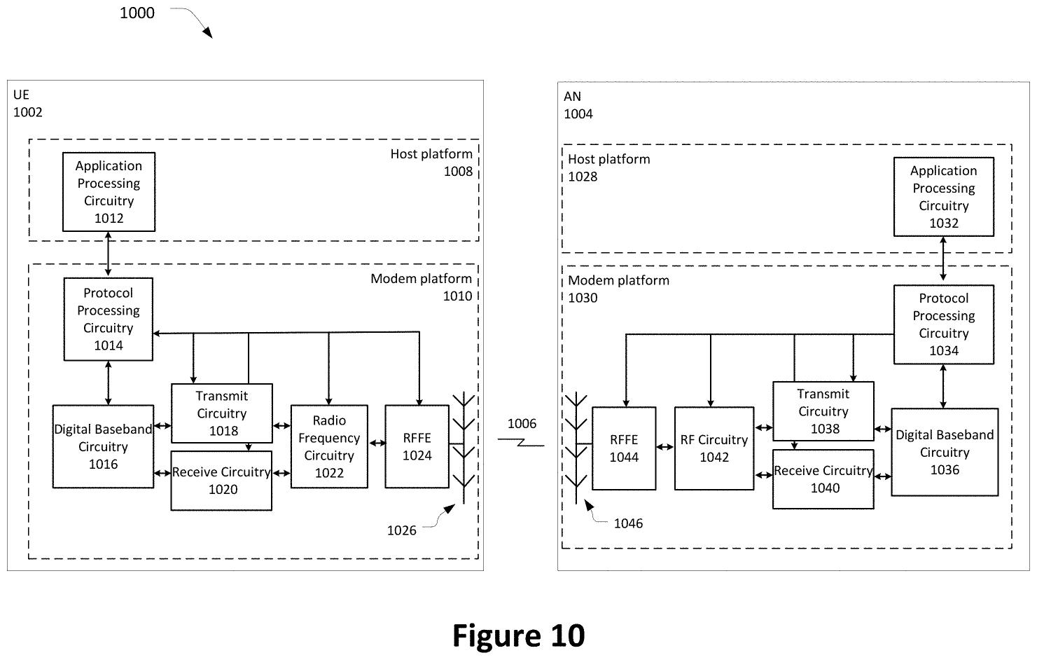

FIG. 10 schematically illustrates a wireless network 1000 in accordance with various embodiments. The wireless network 1000 may include a UE 1002 in wireless communication with an AN 1004. The UE 1002 and AN 1004 may be similar to, and substantially interchangeable with, like-named components described elsewhere herein.

The UE 1002 may be communicatively coupled with the AN 1004 via connection 1006. The connection 1006 is illustrated as an air interface to enable communicative coupling, and can be consistent with cellular communications protocols such as an LTE protocol or a 5G NR protocol operating at mmWave or sub-6 GHz frequencies.

The UE 1002 may include a host platform 1008 coupled with a modem platform 1010. The host platform 1008 may include application processing circuitry 1012, which may be coupled with protocol processing circuitry 1014 of the modem platform 1010. The application processing circuitry 1012 may run various applications for the UE 1002 that source/sink application data. The application processing circuitry 1012 may further implement one or more layer operations to transmit/receive application data to/from a data network. These layer operations may include transport (for example UDP) and Internet (for example, IP) operations

The protocol processing circuitry 1014 may implement one or more of layer operations to facilitate transmission or reception of data over the connection 1006. The layer operations implemented by the protocol processing circuitry 1014 may include, for example, MAC, RLC, PDCP, RRC and NAS operations.

The modem platform 1010 may further include digital baseband circuitry 1016 that may implement one or more layer operations that are “below” layer operations performed by the protocol processing circuitry 1014 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1010 may further include transmit circuitry 1018, receive circuitry 1020, RF circuitry 1022, and RF front end (RFFE) 1024, which may include or connect to one or more antenna panels 1026. Briefly, the transmit circuitry 1018 may include a digital-to-analog converter, mixer, intermediate frequency (IF) components, etc.; the receive circuitry 1020 may include an analog-to-digital converter, mixer, IF components, etc.; the RF circuitry 1022 may include a low-noise amplifier, a power amplifier, power tracking components, etc.; RFFE 1024 may include filters (for example, surface/bulk acoustic wave filters), switches, antenna tuners, beamforming components (for example, phase-array antenna components), etc. The selection and arrangement of the components of the transmit circuitry 1018, receive circuitry 1020, RF circuitry 1022, RFFE 1024, and antenna panels 1026 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1014 may include one or more instances of control circuitry (not shown) to provide control functions for the transmit/receive components.

A UE reception may be established by and via the antenna panels 1026, RFFE 1024, RF circuitry 1022, receive circuitry 1020, digital baseband circuitry 1016, and protocol processing circuitry 1014. In some embodiments, the antenna panels 1026 may receive a transmission from the AN 1004 by receive-beamforming signals received by a plurality of antennas/antenna elements of the one or more antenna panels 1026.

A UE transmission may be established by and via the protocol processing circuitry 1014, digital baseband circuitry 1016, transmit circuitry 1018, RF circuitry 1022, RFFE 1024, and antenna panels 1026. In some embodiments, the transmit components of the UE 1004 may apply a spatial filter to the data to be transmitted to form a transmit beam emitted by the antenna elements of the antenna panels 1026.

Similar to the UE 1002, the AN 1004 may include a host platform 1028 coupled with a modem platform 1030. The host platform 1028 may include application processing circuitry 1032 coupled with protocol processing circuitry 1034 of the modem platform 1030. The modem platform may further include digital baseband circuitry 1036, transmit circuitry 1038, receive circuitry 1040, RF circuitry 1042, RFFE circuitry 1044, and antenna panels 1046. The components of the AN 1004 may be similar to and substantially interchangeable with like-named components of the UE 1002. In addition to performing data transmission/reception as described above, the components of the AN 1008 may perform various logical functions that include, for example, RNC functions such as radio bearer management, uplink and downlink dynamic radio resource management, and data packet scheduling.

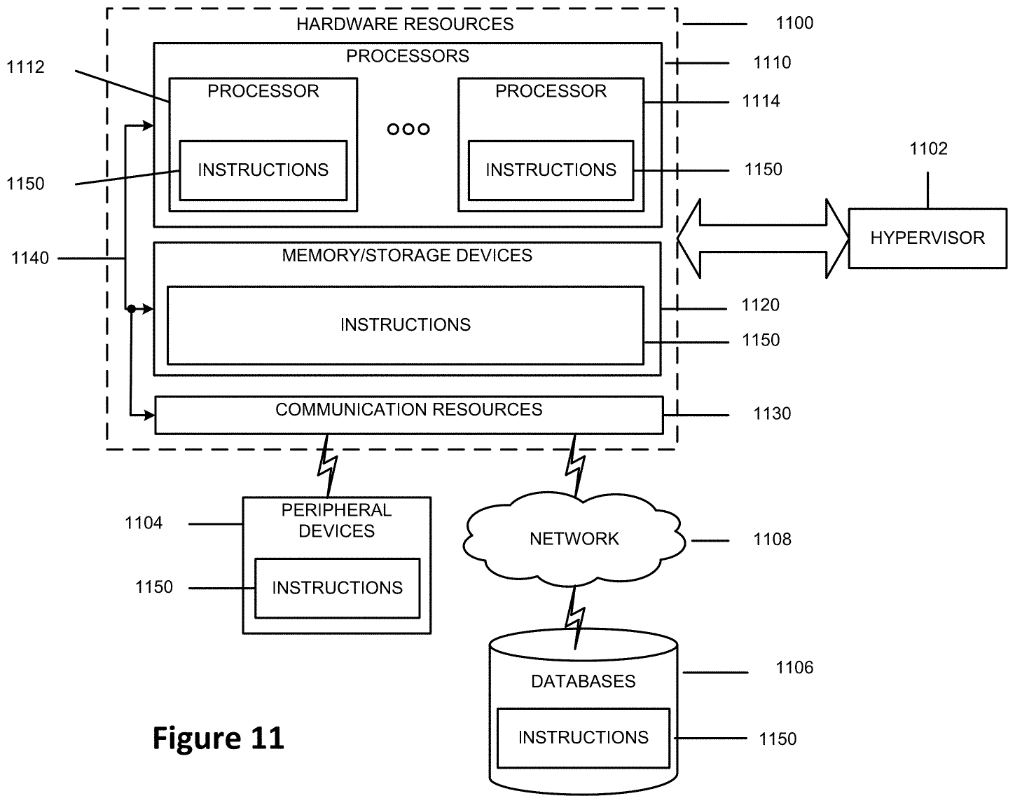

FIG. 11 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1100 including one or more processors (or processor cores) 1110, one or more memory/storage devices 1120, and one or more communication resources 1130, each of which may be communicatively coupled via a bus 1140 or other interface circuitry. For embodiments where node virtualization (e.g., NFV) is utilized, a hypervisor 1102 may be executed to provide an execution environment for one or more network slices/sub-slices to utilize the hardware resources 1100.

The processors 1110 may include, for example, a processor 1112 and a processor 1114. The processors 1110 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1120 may include main memory, disk storage, or any suitable combination thereof. The memory/storage devices 1120 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1130 may include interconnection or network interface controllers, components, or other suitable devices to communicate with one or more peripheral devices 1104 or one or more databases 1106 or other network elements via a network 1108. For example, the communication resources 1130 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1150 may comprise software, a program, an application, an applet, an app, or other executable code for causing at least any of the processors 1110 to perform any one or more of the methodologies discussed herein. The instructions 1150 may reside, completely or partially, within at least one of the processors 1110 (e.g., within the processor's cache memory), the memory/storage devices 1120, or any suitable combination thereof. Furthermore, any portion of the instructions 1150 may be transferred to the hardware resources 1100 from any combination of the peripheral devices 1104 or the databases 1106. Accordingly, the memory of processors 1110, the memory/storage devices 1120, the peripheral devices 1104, and the databases 1106 are examples of computer-readable and machine-readable media.

Example Procedures

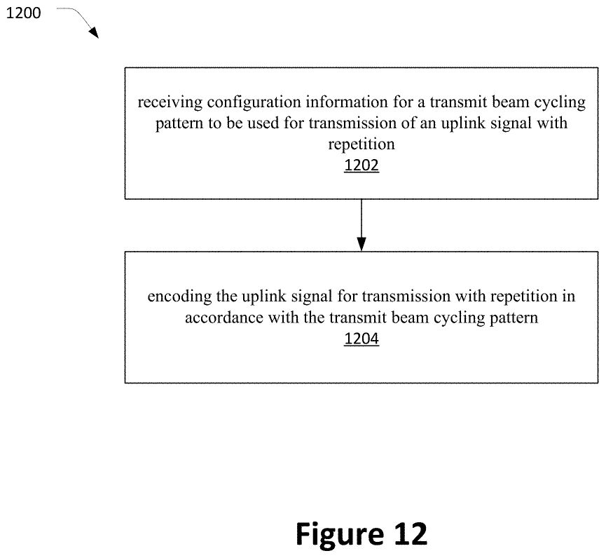

In some embodiments, the electronic device(s), network(s), system(s), chip(s) or component(s), or portions or implementations thereof, of FIGS. 9-11, or some other figure herein, may be configured to perform one or more processes, techniques, or methods as described herein, or portions thereof. One such process 1200 is depicted in FIG. 12. In some embodiments, the process 1200 may be performed by a UE (e.g., UE 902 and/or 1002) or a portion thereof.

For example, the process 1200 may include, at 1202, receiving configuration information for a transmit beam cycling pattern to be used for transmission of an uplink signal with repetition.

At 1204, the process 1200 may further include encoding the uplink signal for transmission with repetition in accordance with the transmit beam cycling pattern. In some embodiments, encoding the uplink signal may include applying a first transmit beam for a first set of one or more transmission occasions of the uplink signal; and applying a second transmit beam for a second set of one or more transmission occasions of the uplink signal.

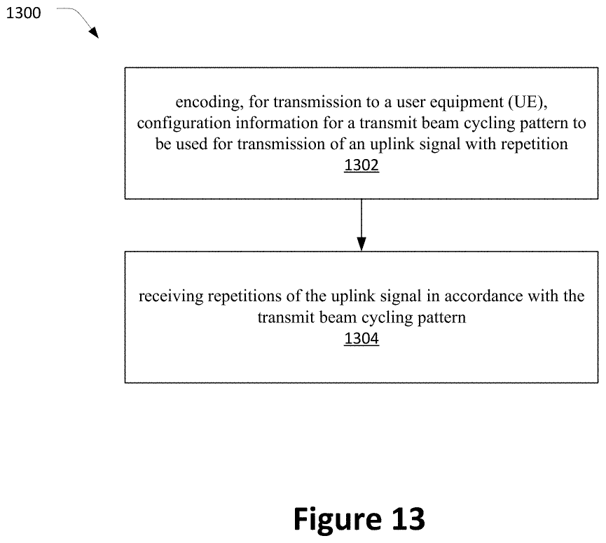

FIG. 13 illustrates another process 1300 in accordance with various embodiments. The process 1300 may be performed by an access node (e.g., AN 908 and/or AN 1004), such as a gNB, or a portion thereof.

For example, the process 1300 may include, at 1302, encoding, for transmission to a user equipment (UE), configuration information for a transmit beam cycling pattern to be used for transmission of an uplink signal with repetition.

At 1304, the process 1300 may further include receiving repetitions of the uplink signal in accordance with the transmit beam cycling pattern. In some embodiments, receiving the repetitions of the uplink signal may include applying a first receive beam for a first set of one or more transmission occasions of the uplink signal; and applying a second receive beam for a second set of one or more transmission occasions of the uplink signal.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include a method of wireless communication for a fifth generation (5G) or new radio (NR) system, the method comprising: receiving, by a UE, configuration of a transmit beam cycling pattern; and transmitting, by the UE, a physical uplink shared channel (PUSCH) and/or a physical uplink control channel (PUCCH) with repetition in accordance with the transmit beam cycling pattern.

Example 2 may include the method of example 1 or some other example herein, wherein a first Tx beam can be applied for a first part of PUSCH and/or PUCCH repetition and a second Tx beam can be applied for a second part of PUSCH and/or PUCCH repetition.

Example 3 may include the method of example 1 or some other example herein, wherein a first Tx beam is applied for the first PUSCH and/or PUCCH transmission occasion or the first slot within the repetition and a second Tx beam is applied for the first PUSCH and/or PUCCH transmission occasion or the first slot within the repetition, wherein the Tx beam pattern is repeated across the PUSCH and/or PUCCH with repetition.

Example 4 may include the method of example 1 or some other example herein, wherein a first Tx beam is applied for the first N PUSCH and/or PUCCH transmission occasions or the first N slot within the repetition and a second Tx beam is applied for the first N PUSCH and/or PUCCH transmission occasions or the first N slots within the repetition; wherein the Tx beam pattern is repeated across the PUSCH and/or PUCCH with repetition.

Example 5 may include the method of claim 4, wherein N can be predefined in the specification, e.g., N=2, or 4, or configured by higher layer via NR remaining minimum system information (RMSI), NR other system information (OSI) or dedicated radio resource control (RRC) signaling or dynamically indicated in the DCI or a combination thereof.

Example 6 may include the method of example 4 or some other example herein, wherein N may be determined in accordance with the number of repetitions for the transmission of PUSCH and/or PUCCH.

Example 7 may include the method of example 1 or some other example herein, wherein beam cycling pattern may be defined such that the number of uplink transmission occasions or slots for one Tx beam can be aligned with the number uplink transmission occasions or slots where same frequency resource is allocated for uplink transmission with repetition.

Example 8 may include the method of example 1 or some other example herein, wherein when a repetition or transmission occasion of the uplink transmission is canceled during the repetition, Tx beam cycling pattern is continued regardless of whether one uplink repetition or transmission occasion is dropped.

Example 9 may include the method of example 1 or some other example herein, wherein for PUSCH repetition type B, beam cycling pattern is applied on the nominal PUSCH repetition.

Example 10 may include the method of example 1 or some other example herein, wherein for PUSCH repetition type B, beam cycling pattern is applied on the actual PUSCH repetition.

Example 11 may include the method of example 1 or some other example herein, wherein when a repetition or transmission occasion of the uplink transmission is canceled during the repetition, the Tx beam cycling pattern is resumed after the cancellation.

Example 12 may include the method of example 1 or some other example herein, wherein a single downlink control information (DCI), e.g., DCI format 0_1 or 0_2, can be used to schedule the PUSCH repetition with beam sweeping operation.

Example 13 may include the method of example 1 or some other example herein, wherein SRS resource indicator in the DCI can be used to indicate the multiple Tx beams used for the transmission of PUSCH with repetition; wherein one codepoint for SRS resource indicator may be pointed to multiple SRS resources which are associated with different Tx beams or SRS-SpatialRelationInfo.

Example 14 may include the method of example 1 or some other example herein, wherein within a SRS resource, multiple SRS-SpatialRelationInfo may be configured to allow the multiple beam transmission for the PUSCH transmission.

Example 15 may include the method of example 1 or some other example herein, wherein multiple PUCCH-SpatialRelationInfo can be configured for each PUCCH resource; wherein more than PUCCH Spatial Relation Info can be active for a PUCCH Resource at a time.

Example 16 may include the method of example 1 or some other example herein, wherein spatial relation info with lower ID is used as a first beam for PUCCH transmission while spatial relation info with larger ID is used as a second beam for PUCCH transmission.

Example 17 may include the method of example 1 or some other example herein, wherein for one PUCCH spatial relation info or PUCCH-SpatialRelationInfo, multiple reference signals can be configured for PUCCH Tx beam.

Example 18 may include the method of example 1 or some other example herein, wherein more than one ssb-Index, csi-RS-Index, or srs in referenceSignal can be configured for PUCCH-SpatialRelationInfo for multiple beam PUCCH transmission.

Example 19 may include a method comprising:

receiving configuration information for a transmit beam cycling pattern; and

encoding an uplink signal for transmission with repetition in accordance with the transmit beam cycling pattern.

Example 20 may include the method of example 19 or some other example herein, wherein the uplink signal is a physical uplink shared channel (PUSCH) or a physical uplink control channel (PUCCH).

Example 21 may include the method of example 19-20 or some other example herein, wherein the transmitting or causing transmission includes: applying a first Tx beam for a first part of an uplink signal repetition; and applying a second Tx beam for a second part of the uplink signal repetition.

Example 22 may include the method of example 19-20 or some other example herein, wherein the transmitting or causing transmission includes: applying a first Tx beam for a first set of one or more transmission occasions or slots of the uplink signal; and applying a second Tx beam for a second set of one or more transmission occasions or slots of the uplink signal.

Example 23 may include the method of example 22 or some other example herein, wherein the transmitting or causing transmission further comprises repeating the transmit beam cycling pattern.

Example 24 may include the method of example 22-23 or some other example herein, wherein the first set of one or more transmission occasions or slots includes a first single slot, and wherein the second set of one or more transmission occasions or slots includes a second single slot after the first single slot.

Example 25 may include the method of example 22-23 or some other example herein, wherein the first and second sets of one or more transmission occasions or slots each include multiple slots.

Example 26 may include the method of example 22-25 or some other example herein, further comprising receiving an indicator of a number of transmission occasions or slots included in the first and/or second sets.

Example 27 may include the method of example 26 or some other example herein, wherein the indicator is received via NR remaining minimum system information (RMSI), NR other system information (OSI), radio resource control (RRC) signaling, and/or downlink control information (DCI).

Example 28 may include the method of example 22-25 or some other example herein, wherein a number of transmission occasions or slots included in the first and/or second sets is predefined.

Example 29 may include the method of example 22-25 or some other example herein, further comprising further comprising determining a number of transmission occasions or slots included in the first and/or second sets based on a number of repetitions of the uplink signal.

Example 30 may include the method of example 22-29 or some other example herein, wherein a number of transmission occasions or slots included in the first and/or second sets corresponds to a number of uplink transmission occasions or slots in which a same frequency resource is allocated for uplink transmission.

Example 31 may include the method of example 19-29 or some other example herein, further comprising receiving a cancellation indication to indicate cancellation of the transmission of the uplink signal on an uplink resource; and continuing the transmission of the uplink signal on remaining uplink resources without regard to the cancellation.

Example 32 may include the method of example 19-30 or some other example herein, further comprising receiving a cancellation indication to indicate cancellation of the transmission of the uplink signal on an uplink resource; and shifting the transmit beam cycling pattern to the next uplink resources allocated for the uplink signal based on the cancellation.

Example 33 may include the method of example 19-32 or some other example herein, further comprising receiving a single downlink control information (DCI) to schedule the transmission of the uplink signal in accordance with the transmit beam cycling pattern.

Example 34 may include the method of example 33 or some other example herein, wherein the DCI has a DCI format 0_1 or 0_2.

Example 35 may include the method of example 33-34 or some other example herein, wherein the DCI includes an SRS resource indicator to indicate multiple Tx beams to be used for the transmission of the uplink signal.

Example 36 may include the method of example 35 or some other example herein, wherein the SRS resource indicator includes one codepoint to indicate multiple SRS resources which are associated with different Tx beams or SRS-SpatialRelationInfo.

Example 37 may include the method of example 19-36 or some other example herein, further comprising receiving configuration information for an SRS resource, wherein the configuration information includes multiple SRS-SpatialRelationInfo for the SRS resource to enable the transmission in accordance with the transmit beam cycling pattern.

Example 38 may include the method of example 37 or some other example herein, further comprising receiving multiple PUCCH-SpatialRelationInfo information elements for a PUCCH resource; and receiving an indicator to indicate one of the PUCCH-SpatialRelationInfo information elements that is active for the transmission of the uplink signal.

Example 39 may include the method of example 19-38 or some other example herein, further comprising: receiving a first spatial relation information and a second spatial relation information; using a first one of the first or second spatial relation information that has a lower ID for a first beam of the transmission; and using a second one of the first or second spatial relation information that has a higher ID for a second beam of the transmission.

Example 40 may include the method of example 19-39 or some other example herein, wherein the configuration information includes a PUCCH spatial relation information element to configure multiple reference signals for a PUCCH Tx beam.

Example 41 may include the method of example 19-40 or some other example herein, wherein the configuration information includes a PUCCH spatial relation information element to configure more than one ssb-Index, csi-RS-Index, and/or SRS for a multiple beam PUCCH transmission.

Example 42 may include the method of example 19-41 or some other example herein, wherein the uplink signal is a PUSCH with repetition type B, and wherein the beam cycling pattern is applied to repetitions of the PUSCH prior to segmenting the repetitions due to one or more conflicts.

Example 43 may include the method of example 19-41 or some other example herein, wherein the uplink signal is a PUSCH with repetition type B, and wherein the beam cycling pattern is applied to repetitions of the PUSCH after segmenting the repetitions due to one or more conflicts.

Example 44 may include the method of example 42-43 or some other example herein, wherein the one or more conflicts include a conflict with a DL symbol, an invalid symbol, and/or a slot boundary.

Example 45 may include the method of examples 19-44 or some other example herein, wherein the method is performed by a user equipment (UE) or a portion thereof.

Example 46 may include a method comprising:

encoding, for transmission to a user equipment (UE), configuration information for a transmit beam cycling pattern; and

receiving, from the UE, an uplink signal with repetition in accordance with the transmit beam cycling pattern.

Example 47 may include the method of example 46 or some other example herein, wherein the uplink signal is a physical uplink shared channel (PUSCH) or a physical uplink control channel (PUCCH).

Example 48 may include the method of example 46-47 or some other example herein, wherein receiving the uplink signal includes applying a first Rx beam for a first part of an uplink signal repetition; and applying a second Rx beam for a second part of the uplink signal repetition.

Example 49 may include the method of example 46-48 or some other example herein, wherein the receiving the uplink signal includes: applying a first Rx beam for a first set of one or more transmission occasions or slots of the uplink signal; and applying a second Rx beam for a second set of one or more transmission occasions or slots of the uplink signal.

Example 50 may include the method of example 49 or some other example herein, wherein the receiving further comprises repeating the transmit beam cycling pattern.

Example 51 may include the method of example 49-50 or some other example herein, wherein the first set of one or more transmission occasions or slots includes a first single slot, and wherein the second set of one or more transmission occasions or slots includes a second single slot after the first single slot.

Example 52 may include the method of example 49-51 or some other example herein, wherein the first and second sets of one or more transmission occasions or slots each include multiple slots.

Example 53 may include the method of example 49-52 or some other example herein, further comprising transmitting or causing transmission of, to the UE, an indicator of a number of transmission occasions or slots included in the first and/or second sets.

Example 54 may include the method of example 53 or some other example herein, wherein the indicator is transmitted via NR remaining minimum system information (RMSI), NR other system information (OSI), radio resource control (RRC) signaling, and/or downlink control information (DCI).

Example 55 may include the method of example 46-54 or some other example herein, wherein the configuration information includes a PUCCH spatial relation information element to configure multiple reference signals for a PUCCH Tx beam.

Example 56 may include the method of example 46-55 or some other example herein, wherein the configuration information includes a PUCCH spatial relation information element to configure more than one ssb-Index, csi-RS-Index, and/or SRS for a multiple beam PUCCH transmission.

Example 57 may include the method of example 46-56 or some other example herein, wherein the uplink signal is a PUSCH with repetition type B, and wherein the beam cycling pattern is applied to repetitions of the PUSCH prior to segmenting the repetitions due to one or more conflicts.

Example 58 may include the method of example 46-56 or some other example herein, wherein the uplink signal is a PUSCH with repetition type B, and wherein the beam cycling pattern is applied to repetitions of the PUSCH after segmenting the repetitions due to one or more conflicts.

Example 59 may include the method of example 46-58 or some other example herein, wherein the one or more conflicts include a conflict with a DL symbol, an invalid symbol, and/or a slot boundary.

Example 60 may include the method of example 46-59 or some other example herein, wherein the method is performed by a next generation Node B (gNB) or a portion thereof.

Example 61 may include an apparatus comprising means to perform one or more elements of a method described in or related to any of examples 1-60, or any other method or process described herein.

Example 62 may include one or more non-transitory computer-readable media comprising instructions to cause an electronic device, upon execution of the instructions by one or more processors of the electronic device, to perform one or more elements of a method described in or related to any of examples 1-60, or any other method or process described herein.

Example 63 may include an apparatus comprising logic, modules, or circuitry to perform one or more elements of a method described in or related to any of examples 1-60, or any other method or process described herein.

Example 64 may include a method, technique, or process as described in or related to any of examples 1-60, or portions or parts thereof.

Example 65 may include an apparatus comprising: one or more processors and one or more computer-readable media comprising instructions that, when executed by the one or more processors, cause the one or more processors to perform the method, techniques, or process as described in or related to any of examples 1-60, or portions thereof.

Example 66 may include a signal as described in or related to any of examples 1-52, or portions or parts thereof.

Example 67 may include a datagram, packet, frame, segment, protocol data unit (PDU), or message as described in or related to any of examples 1-60, or portions or parts thereof, or otherwise described in the present disclosure.

Example 68 may include a signal encoded with data as described in or related to any of examples 1-60, or portions or parts thereof, or otherwise described in the present disclosure.

Example 69 may include a signal encoded with a datagram, packet, frame, segment, protocol data unit (PDU), or message as described in or related to any of examples 1-60, or portions or parts thereof, or otherwise described in the present disclosure.

Example 70 may include an electromagnetic signal carrying computer-readable instructions, wherein execution of the computer-readable instructions by one or more processors is to cause the one or more processors to perform the method, techniques, or process as described in or related to any of examples 1-60, or portions thereof.

Example 71 may include a computer program comprising instructions, wherein execution of the program by a processing element is to cause the processing element to carry out the method, techniques, or process as described in or related to any of examples 1-60, or portions thereof.

Example 72 may include a signal in a wireless network as shown and described herein.

Example 73 may include a method of communicating in a wireless network as shown and described herein.

Example 74 may include a system for providing wireless communication as shown and described herein.

Example 75 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | |
|---|---|
| 3GPP | Third Generation |
| | Partnership Project |
| 4G | Fourth Generation |
| 5G | Fifth Generation |
| 5GC | 5G Core network |
| ACK | Acknowledgement |
| AF | Application |
| | Function |
| AM | Acknowledged |
| | Mode |
| AMBR | Aggregate |
| | Maximum Bit Rate |
| AMF | Access and |
| | Mobility |
| | Management |
| | Function |
| AN | Access Network |
| ANR | Automatic |
| | Neighbour Relation |
| AP | Application |
| | Protocol, Antenna |
| | Port, Access Point |
| API | Application |
| | Programming Interface |
| APN | Access Point Name |
| ARP | Allocation and |
| | Retention Priority |
| ARQ | Automatic Repeat |
| | Request |
| AS | Access Stratum |
| ASN.1 | Abstract Syntax |
| | Notation One |
| AUSF | Authentication |
| | Server Function |
| AWGN | Additive White |
| | Gaussian Noise |
| BAP | Backhaul |
| | Adaptation Protocol |
| BCH | Broadcast Channel |
| BER | Bit Error Ratio |
| BFD | Beam Failure |
| | Detection |
| BLER | Block Error Rate |
| BPSK | Binary Phase Shift |
| | Keying |
| BRAS | Broadband Remote |
| | Access Server |
| BSS | Business Support |
| | System |
| BS | Base Station |
| BSR | Buffer Status |
| | Report |
| BW | Bandwidth |
| BWP | Bandwidth Part |
| C-RNTI | Cell Radio |
| | Network Temporary |
| | Identity |
| CA | Carrier Aggregation, |
| | Certification Authority |
| CAPEX | CAPital |
| | EXpenditure |
| CBRA | Contention Based |
| | Random Access |
| CC | Component Carrier, |
| | Country Code, |
| | Cryptographic |
| | Checksum |
| CCA | Clear Channel |
| | Assessment |
| CCE | Control Channel |
| | Element |
| CCCH | Common Control |
| | Channel |
| CE | Coverage Enhancement |
| CDM | Content Delivery |
| | Network |
| CDMA | Code-Division |
| | Multiple Access |
| CFRA | Contention Free |
| | Random Access |
| CG | Cell Group |
| CI | Cell Identity |
| CID | Cell-ID (e.g., |
| | positioning method) |
| CIM | Common Information |
| | Model |
| CIR | Carrier to Interference |
| | Ratio |
| CK | Cipher Key |
| CM | Connection Management, |
| | Conditional Mandatory |
| CMAS | Commercial Mobile |
| | Alert Service |
| CMD | Command |
| CMS | Cloud Management |
| | System |
| CO | Conditional Optional |
| CoMP | Coordinated Multi-Point |
| CORESET | Control Resource Set |
| COTS | Commercial Off- |
| | The-Shelf |
| CP | Control Plane, |
| | Cyclic Prefix, |
| | Connection Point |
| CPD | Connection Point |
| | Descriptor |
| CPE | Customer Premise |
| | Equipment |
| CPICH | Common Pilot Channel |
| CQI | Channel Quality |
| | Indicator |
| CPU | CSI processing unit, |
| | Central Processing Unit |
| C/R | Command/Response |
| | field bit |
| CRAN | Cloud Radio |
| | Access Network, |
| | Cloud RAN |
| CRB | Common Resource |
| | Block |
| CRC | Cyclic Redundancy |
| | Check |
| CRI | Channel-State |
| | Information Resource |
| | Indicator, CSI-RS |
| | Resource Indicator |
| C-RNTI | Cell RNTI |
| CS | Circuit Switched |
| CSAR | Cloud Service Archive |
| CSI | Channel-State |
| | Information |
| CSI-IM | CSI Interference |
| | Measurement |
| CSI-RS | CSI Reference Signal |
| CSI-RSRP | CSI reference signal |
| | received power |
| CSI-RSRQ | CSI reference signal |
| | received quality |
| CSI-SINR | CSI signal-to-noise and |
| | interference ratio |
| CSMA | Carrier Sense Multiple |
| | Access |
| CSMA/CA | CSMA with collision |
| | avoidance |
| CSS | Common Search |
| | Space, Cell-specific |
| | Search Space |
| CTS | Clear-to-Send |
| CW | Codeword |
| CWS | Contention Window Size |
| D2D | Device-to-Device |
| DC | Dual Connectivity, |
| | Direct Current |
| DCI | Downlink Control |
| | Information |
| DF | Deployment Flavour |
| DL | Downlink |
| DMTF | Distributed Management |
| | Task Force |
| DPDK | Data Plane Development |
| | Kit |
| DM-RS, | DMRS Demodulation |
| | Reference Signal |
| DN | Data network |
| DRB | Data Radio Bearer |
| DRS | Discovery Reference |
| | Signal |
| DRX | Discontinuous |
| | Reception |
| DSL | Domain Specific |
| | Language. Digital |
| | Subscriber Line |
| DSLAM | DSL Access Multiplexer |
| DwPTS | Downlink Pilot Time |
| | Slot |
| E-LAN | Ethernet Local Area |
| | Network |
| E2E | End-to-End |
| ECCA | extended clear channel |
| | assessment, extended |
| | CCA |
| ECCE | Enhanced Control |
| | Channel Element, |
| | Enhanced CCE |
| ED | Energy Detection |
| EDGE | Enhanced Datarates |
| | for GSM Evolution |
| | (GSM Evolution) |
| EGMF | Exposure Governance |
| | Management Function |
| EGPRS | Enhanced GPRS |
| EIR | Equipment Identity |
| | Register |
| eLAA | enhanced Licensed |
| | Assisted Access, |
| | enhanced LAA |
| EM | Element Manager |
| eMBB | Enhanced Mobile |
| | Broadband |
| EMS | Element Management |
| | System |
| eNB | evolved NodeB, |
| | E-UTRAN Node B |
| EN-DC | E-UTRA-NR Dual |
| | Connectivity |
| EPC | Evolved Packet Core |
| EPDCCH | enhanced PDCCH, |
| | enhanced Physical |
| | Downlink Control Cannel |
| EPRE | Energy per resource |
| | element |
| EPS | Evolved Packet System |
| EREG | enhanced REG, |
| | enhanced resource |
| | element groups |
| ETSI | European |
| | Telecommunications |
| | Standards Institute |
| ETWS | Earthquake and Tsunami |
| | Warning System |
| eUICC | embedded UICC, |
| | embedded Universal |
| | Integrated Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane |
| | interface |
| F1-U | F1 User plane interface |
| FACCH | Fast Associated Control |
| | CHannel |
| FACCH/F | Fast Associated Control |
| | Channel/Full rate |
| FACCH/H | Fast Associated Control |
| | Channel/Half rate |
| FACH | Forward Access |
| | Channel |
| FAUSCH | Fast Uplink Signalling |
| | Channel |
| FB | Functional Block |
| FBI | Feedback Information |
| FCC | Federal Communications |
| | Commission |
| FCCH | Frequency Correction |
| | CHannel |
| FDD | Frequency Division |
| | Duplex |
| FDM | Frequency Division |
| | Multiplex |
| FDMA | Frequency Division |
| | Multiple Access |
| FE | Front End |
| FEC | Forward Error Correction |
| FFS | For Further Study |
| FFT | Fast Fourier |
| | Transformation |
| feLAA | further enhanced |
| | Licensed Assisted |
| | Access, further |
| | enhanced LAA |
| FN | Frame Number |
| FPGA | Field-Programmable |
| | Gate Array |
| FR | Frequency Range |
| G-RNTI | GERAN Radio Network |
| | Temporary Identity |
| GERAN | GSM EDGE RAN, |
| | GSM EDGE Radio |
| | Access Network |
| GGSN | Gateway GPRS |
| | Support Node |
| GLONASS | GLObal′naya |
| | NAvigatsionnaya |
| | Sputnikovaya |
| Sistema | (Engl.: Global Navigation |
| | Satellite System) |
| gNB | Next Generation NodeB |
| gNB-CU | gNB-centralized unit, |
| | Next Generation NodeB |
| | centralized unit |
| gNB-DU | gNB-distributed unit, |
| | Next Generation NodeB |
| | distributed unit |
| GNSS | Global Navigation |
| | Satellite System |
| GPRS | General Packet Radio |
| | Service |
| GSM | Global System for |
| | Mobile Communications, |
| | Groupe Spécial Mobile |
| GTP | GPRS Tunneling |
| | Protocol |
| GTP-UGPRS | Tunnelling Protocol |
| | for User Plane |
| GTS | Go To Sleep Signal |
| | (related to WUS) |
| GUMMEI | Globally Unique MME |
| | Identifier |
| GUTI | Globally Unique |
| | Temporary UE Identity |
| HARQ | Hybrid ARQ, Hybrid |
| | Automatic Repeat |
| | Request |
| HANDO | Handover |
| HFN | HyperFrame Number |
| HHO | Hard Handover |
| HLR | Home Location Register |
| HN | Home Network |
| HO | Handover |
| HPLMN | Home Public Land |
| | Mobile Network |
| HSDPA | High Speed Downlink |
| | Packet Access |
| HSN | Hopping Sequence |
| | Number |
| HSPA | High Speed Packet |
| | Access |
| HSS | Home Subscriber Server |
| HSUPA | High Speed Uplink |
| | Packet Access |
| HTTP | Hyper Text Transfer |
| | Protocol |
| HTTPS | HyperText Transfer |
| | Protocol Secure (https is |
| | http/1.1 over SSL, |
| | i.e. port 443) |
| I-Block | Information Block |
| ICCID | Integrated Circuit |
| | Card Identification |
| IAB | Integrated Access |
| | and Backhaul |
| ICIC | Inter-Cell Interference |
| | Coordination |
| ID | Identity, identifier |
| IDFT | Inverse Discrete Fourier |
| | Transform |
| IE | Information element |
| IBE | In-Band Emission |
| IEEE | Institute of Electrical |
| | and Electronics |
| | Engineers |
| IEI | Information Element |
| | Identifier |
| IEIDL | Information Element |
| | Identifier Data Length |
| IETF | Internet Engineering |
| | Task Force |
| IF | Infrastructure |
| IM | Interference |
| | Measurement, |
| | Intermodulation, IP |
| | Multimedia |
| IMC | IMS Credentials |
| IMEI | International Mobile |
| | Equipment Identity |
| IMGI | International mobile |
| | group identity |
| IMPI IP | Multimedia Private |
| | Identity |
| IMPU | IP Multimedia PUblic |
| | identity |
| IMS | IP Multimedia |
| | Subsystem |
| IMSI | International Mobile |
| | Subscriber Identity |
| IoT | Internet of Things |
| IP | Internet Protocol |
| Ipsec | IP Security, |
| | Internet Protocol |
| | Security |
| IP-CAN | IP-Connectivity Access |
| | Network |
| IP-M | IP Multicast |
| IPv4 | Internet Protocol |
| | Version 4 |
| IPv6 | Internet Protocol |
| | Version 6 |
| IR | Infrared |
| IS | In Sync |
| IRP | Integration Reference |
| | Point |
| ISDN | Integrated Services |
| | Digital Network |
| ISIM | IM Services Identity |
| | Module |
| ISO | International |
| | Organisation for |
| | Standardisation |
| ISP | Internet Service |
| | Provider |
| IWF | Interworking-Function |
| I-WLAN | Interworking WLAN |
| | Constraint length of |
| | the convolutional code, |
| | USIM Individual key |
| | kB Kilobyte (1000 bytes) |
| kbps | kilo-bits per second |
| Kc | Ciphering key |
| Ki | Individual subscriber |
| | authentication key |
| KPI | Key Performance |
| | Indicator |
| KQI | Key Quality Indicator |
| KSI | Key Set Identifier |
| ksps | kilo-symbols per |
| | second |
| KVM | Kernel Virtual Machine |
| L1 | Layer 1 (physical layer) |
| Ll-RSRP | Layer 1 reference signal |
| | received power |
| L2 | Layer 2 (data link layer) |
| L3 | Layer 3 (network layer) |
| LAA | Licensed Assisted |
| | Access |
| LAN | Local Area Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, |
| | Low Layer Compatibility |
| LPLMN | Local PLMN |
| LPP | LTE Positioning |
| | Protocol |
| LSB | Least Significant Bit |
| LTE | Long Term Evolution |
| LWA | LTE-WLAN aggregation |
| LWIP LTE/ | Level Integration with |
| WLAN Radio | IPsec Tunnel LTE |
| | Long Term Evolution |
| M2M | Machine-to-Machine |
| MAC | Medium Access Control |
| | (protocol layering context) |
| MAC | Message authentication |
| | code (security/encryption |
| | context) |
| MAC-A | MAC used for |
| | authentication and |
| | key agreement (TSG T |
| | WG3 context) |
| MAC-IMAC | used for data integrity of |
| | signalling messages (TSG |
| | TWG3 context) |
| MANO | Management and |
| | Orchestration |
| MBMS | Multimedia Broadcast |
| | and Multicast Service |
| MBSFN | Multimedia Broadcast |
| | multicast service Single |
| | Frequency Network |
| MCC | Mobile Country Code |
| MCG | Master Cell Group |
| MCOT | Maximum Channel |
| | Occupancy Time |
| MCS | Modulation and coding |
| | scheme |
| MDAF | Management Data |
| | Analytics Function |
| MDAS | Management Data |
| | Analytics Service |
| MDT | Minimization of |
| | Drive Tests |
| ME | Mobile Equipment |
| MeNB | master eNB |
| MER | Message Error Ratio |
| MGL | Measurement Gap Length |
| MGRP | Measurement Gap |
| | Repetition Period |
| MIB | Master Information |
| | Block, Managemen |
| | Information Base |
| MIMO | Multiple Input |
| | Multiple Output |
| MLC | Mobile Location Centre |
| MM | Mobility Management |
| MME | Mobility Management |
| | Entity |
| MN | Master Node |
| MnS | Management Service |
| MO | Measurement Object, |
| | Mobile Originated |
| MPBCH | MTC Physical Broadcast |
| | CHannel |
| MPDCCH | MTC Physical Downlink |
| | Control CHannel |
| MPDSCH | MTC Physical Downlink |
| | Shared CHannel |
| MPRACH | MTC Physical Random |
| | Access CHannel |
| MPUSCH | MTC Physical Uplink Shared |
| | Channel |
| MPLS | Multiprotocol Label |
| | Switching |
| MS | Mobile Station |
| MSB | Most Significant Bit |
| MSC | Mobile Switching Centre |
| MSI | Minimum System |
| | Information, MCH |
| | Scheduling Information |
| MSID | Mobile Station Identifier |
| MSIN | Mobile Station Identification |
| | Number |
| MSISDN | Mobile Subscriber ISDN |
| | Number |
| MT | Mobile Terminated, |
| | Mobile Termination |
| MTC | Machine-Type |
| | Communications |
| mMTCmassive | MTC, massive Machine- |
| | Type Communications |
| MU-MIMO | Multi User MIMO |
| MWUS | MTC wake-up signal, MTC |
| | WUS |
| NACK | Negative Acknowledgement |
| NAI | Network Access Identifier |
| NAS | Non-Access Stratum, Non- |
| | Access Stratum layer |
| NCT | Network Connectivity |
| | Topology |
| NC-JT | Non-coherent Joint |
| | Transmission |
| NEC | Network Capability |
| | Exposure |
| NE-DC | NR-E-UTRA Dual |
| | Connectivity |
| NEF | Network Exposure |
| | Function |
| NF | Network Function |
| NFP | Network Forwarding Path |
| NFPD | Network Forwarding Path |
| | Descripton |
| NFV | Network Functions |
| | Virtualization |
| NFVI | NFV Infrastructure |
| NFVO | NFV Orchestrator |
| NG | Next Generation, |
| | Next Gen |
| NGEN-DC | NG-RAN E-UTRA-NR Dual |
| | Connectivity |
| NM | Network Manager |
| NMS | Network Management |
| | System |
| N-PoP | Network Point of Presence |
| NMIB, N-MIB | Narrowband MIB |
| NPBCH | Narrowband Physical |
| | Broadcast CHannel |
| NPDCCH | Narrowband Physical |
| | Downlink Control CHannel |
| NPDSCH | Narrowband Physical |
| | Downlink Shared CHannel |
| NPRACH | Narrowband Physical Random |
| | Access CHannel |
| NPUSCH | Narrowband Physical Uplink |
| | Shared CHannel |
| NPSS | Narrowband Primary |
| | Synchronization Signal |
| NSSS | Narrowband Secondary |
| | Synchronization Signal |
| NR | New Radio, |
| | Neighbour Relation |
| NRF | NF Repository Function |
| NRS | Narrowband Reference Signal |
| NS | Network Service |
| NSA | Non-Standalone |
| | operation mode |
| NSD | Network Service Descriptor |
| NSR | Network Service Record |
| NSSAI | Network Slice Selection |
| | Assistance Information |
| S-NNSAI | Single-NSSAI |
| NSSF | Network Slice Selection |
| | Function |
| NW | Network |
| NWUS | Narrowband wake-up signal, |
| | Narrowband WUS |
| NZP | Non-Zero Power |
| O&M | Operation and Maintenance |
| ODU2 | Optical channel Data |
| | Unit-type 2 |
| OFDM | Orthogonal Frequency |
| | Division Multiplexing |
| OFDMA | Orthogonal Frequency |
| | Division Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power |
| | Ratio |
| PAR | Peak to Average Ratio |
| PBCH | Physical Broadcast Channel |
| PC | Power Control, |
| | Personal Computer |
| PCC | Primary Component Carrier, |
| | Primary CC |
| PCell | Primary Cell |
| PCI | Physical Cell ID, |
| | Physical Cell Identity |
| PCEF | Policy and Charging |
| | Enforcement Function |
| PCF | Policy Control Function |
| PCRF | Policy Control and Charging |
| | Rules Function |
| PDCP | Packet Data Convergence |
| | Protocol, Packet Data |
| | Convergence Protocol |
| | layer |
| PDCCH | Physical Downlink Control |
| | Channel |
| PDCP | Packet Data Convergence |
| | Protocol |
| PDN | Packet Data Network, |
| | Public Data Network |
| PDSCH | Physical Downlink Shared |
| | Channel |
| PDU | Protocol Data Unit |
| PEI | Permanent Equipment |
| | Identifiers |
| PFD | Packet Flow Description |
| P-GW | PDN Gateway |
| PHICH | Physical hybrid-ARQ |
| | indicator channel |
| PHY | Physical layer |
| PLMN | Public Land Mobile |
| | Network |
| PIN | Personal Identification |
| | Number |
| PM | Performance Measurement |
| PMI | Precoding Matrix Indicator |
| PNF | Physical Network Function |
| PNFD | Physical Network Function |
| | Descriptor |
| PNFR | Physical Network Function |
| | Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block group |
| ProSe | Proximity Services, |
| | Proximity-Based Service |
| PRS | Positioning Reference Signal |
| PRR | Packet Reception Radio |
| PS | Packet Services |
| PSBCH | Physical Sidelink Broadcast |
| | Channel |
| PSDCH | Physical Sidelink Downlink |
| | Channel |
| PSCCH | Physical Sidelink Control |
| | Channel |
| PSFCH | Physical Sidelink Feedback |
| | Channel |
| PSSCH | Physical Sidelink Shared |
| | Channel |
| PSCell | Primary SCell |
| PSS | Primary Synchronization |
| | Signal |
| PSTN | Public Switched |
| | Telephone Network |
| PT-RS | Phase-tracking reference |
| | signal |
| PTT | Push-to-Talk |
| PUCCH | Physical Uplink Control |
| | Channel |
| PUSCH | Physical Uplink Shared |
| | Channel |
| QAM | Quadrature Amplitude |
| | Modulation |
| QCI | QoS class of identifier |
| QCL | Quasi co-location |
| QFI | QoS Flow ID, QoS Flow |
| | Identifier |
| QoS | Quality of Service |
| QPSK | Quadrature Quaternary) Phase |
| | Shift Keying |
| QZSS | Quasi-Zenith Satellite System |
| RA-RNTI | Random Access RNTI |
| RAB | Radio Access Bearer, |
| | Random Access Burst |
| RACH | Random Access Channel |
| RADIUS | Remote Authentication Dial |
| | In User Service |
| RAN | Radio Access Network |
| RAND | RANDom number |
| | (used for authentication) |
| RAR | Random Access Response |
| RAT | Radio Access Technology |
| RAU | Routing Area Update |
| RB | Resource block. |
| | Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, |
| | Radio Link Control layer |
| RLC AM | RLC Acknowledged Mode |
| RLC UM | RLC Unacknowledged Mode |
| RLF | Radio Link Failure |
| RLM | Radio Link Monitoring |
| RLM-RS | Reference Signal for RLM |
| RM | Registration Management |
| RMC | Reference Measurement |
| | Channel |
| RMSI | Remaining MSI, |
| | Remaining Minimum |
| | System Information |
| RN | Relay Node |
| RNC | Radio Network Controller |
| RNL | Radio Network Layer |
| RNTI | Radio Network Temporary |
| | Identifier |
| ROHC | RObust Header Compression |
| RRC | Radio Resource Control, |
| | Radio Resource Control |
| | layer |
| RRM | Radio Resource Management |
| RS | Reference Signal |
| RSRP | Reference Signal Received |
| | Power |
| RSRQ | Reference Signal Received |
| | Quality |
| RSSI | Received Signal Strength |
| | Indicator |
| RSU | Road Side Unit |
| RSTD | Reference Signal Time |
| | difference |
| RTP | Real Time Protocol |
| RTS | Ready-To-Send |
| RTT | Round Trip Time |
| Rx | Reception, Receiving, |
| | Receiver |
| S1AP | S1 Application Protocol |
| S1-MME | S1 for the control plane |
| S1-U | S1 for the user plane |
| S-GW | Serving Gateway |
| S-RNTI | SRNC Radio Network |
| | Temporary Identity |
| S-TMSI | SAE Temporary Mobile |
| | Station Identifier |
| SA | Standalone operation mode |
| SAE | System Architecture |
| | Evolution |
| SAP | Service Access Point |
| SAPD | Service Access Point |
| | Descriptor |
| SAPI | Service Access Point |
| | Identifier |
| SCC | Secondary Component |
| | Carrier, Secondary CC |
| SCell | Secondary Cell |
| SC-FDMA | Single Carrier Frequency |
| | Division Multiple Access |
| SCG | Secondary Cell Group |
| SCM | Security Context Management |
| SCS | Subcarrier Spacing |
| SCTP | Stream Control Transmission |
| | Protocol |
| SDAP | Sendee Data Adaptation |
| | Protocol, Service Data |
| | Adaptation Protocol layer |
| SDL | Supplementary Downlink |
| SDNF | Structured Data Storage |
| | Network Function |
| SDP | Session Description |
| | Protocol |
| SDSF | Structured Data Storage |
| | Function |
| SDU | Service Data Unit |
| SEAF | Security Anchor Function |
| SeNB | secondary eNB |
| SEPP | Security Edge Protection |
| | Proxy |
| SFI | Slot formatindication |
| SFTD | Space-Frequency Time |
| | Diversity, SFN and frame |
| | timing difference SFN System |
| | Frame Number or Single |
| | Frequency-Network |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management |
| | Function |
| SMS | Short Message Service |
| SMSF | SMS Function |
| SMTC | SSB-based Measurement |
| | Timing Configuration |
| SN | Secondary Node, |
| | Sequence Number |
| SoC | System on Chip |
| SON | Self-Organizing Network |
| SpCell | Special Cell |
| SP-CSI-RNTISemi- | Persistent CSI RNTI |
| SPS | Semi-Persistent |
| | Scheduling |
| SQN | Sequence number |
| SR | Scheduling Request |
| SRB | Signalling Radio Bearer |
| SRS | Sounding Reference Signal |
| SS | Synchronization Signal |
| SSB | SS Block |
| SSBRI | SSB Resource Indicator |
| SSC | Session and Service |
| | Continuity |
| SS-RSRP | Synchronization Signal |
| | based Reference Signal |
| | Received Power |
| SS-RSRQ | Synchronization Signal |
| | based Reference Signal |
| | Received Quality |
| SS-SINR | Synchronization Signal |
| | based Signal to Noise and |
| | Interference Ratio |
| SSS | Secondary Synchronization |
| | Signal |
| SSSG | Search Space Set Group |
| SSSIF | Search Space Set Indicator |
| SST | Slice/Service Types |
| SU-MIMO | Single User MIMO |
| SUL | Supplementary Uplink |
| TA | Timing Advance, |
| | Tracking Area |
| TAC | Tracking Area Code |
| TAG | Timing Advance Group |
| TAU | Tracking Area Update |
| TB | Transport Block |
| TBS | Transport Block Size |
| TBD | To Be Defined |
| TCI | Transmission Configuration |
| | Indicator |
| TCP | Transmission Communication |
| | Protocol |
| TDD | Time Division Duplex |
| TDM | Time Division Multiplexing |
| TDMA | Time Division Multiple |
| | Access |
| TE | Terminal Equipment |
| TEID | Tunnel End Point Identifier |
| TFT | Traffic Flow Template |
| TMSI | Temporary Mobile |
| | Subscriber Identity |
| TNL | Transport Network Layer |
| TPC | Transmit Power Control |
| TPMI | Transmitted Precoding Matrix |
| | Indicator |
| TR | Technical Report |
| TRP, TRxP | Transmission |
| | Reception Point |
| TRS | Tracking Reference Signal |
| TRx | Transceiver |
| TS | Technical Specifications, |
| | Technical Standard |
| TTI | Transmission Time Interval |
| Tx | Transmission, Transmitting, |
| | Transmitter |
| U-RNTI | UTRAN Radio Network |
| | Temporary Identity |
| UART | Universal Asynchronous |
| | Receiver and Transmitter |
| UCI | Uplink Control Information |
| UE | User Equipment |
| UDM | Unified Data Management |
| UDP | User Datagram Protocol |
| UDR | Unified Data Repository |
| UDSF | Unstructured Data |
| | Storage Network Function |
| UICC | Universal Integrated Circuit |
| | Card |
| UL | Uplink |
| UM | Unacknowledged Mode |
| UML | Unified Modelling Language |
| UMTS | Universal Mobile |
| | Telecommunications |
| | System |
| UP | User Plane |
| UPF | User Plane Function |
| URI | Uniform Resource Identifier |
| URL | Uniform Resource Locator |
| URLLC | Ultra-Reliable and Low |
| | Latency |
| USB | Universal Serial Bus |
| USIM | Universal Subscriber Identity |
| | Module |
| USS | UE-specific search space |
| UTRA | UMTS Terrestrial Radio |
| | Access |
| UTRAN | Universal Terrestrial Radio |
| | Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure |
| | Manager |
| VL | Virtual Link, |
| VLAN | Virtual LAN, Virtual Local |
| | Area Network |
| VM | Virtual Machine |
| VNF | Virtualized Network Function |
| VNFFG | VNF Forwarding Graph |
| VNFFGD | VNF Forwarding Graph |
| | Descriptor |
| VNFM | VNF Manager |
| VoIP | Voice-over-IP, |
| | Voice-over-Internet Protocol |
| VPLMN | Visited Public Land Mobile |
| | Network |
| VPN | Virtual Private Network |
| VRB | Virtual Resource Block |
| WiMAX | Worldwide Interoperability |
| | for Microwave Access |
| WLANWireless | Local Area Network |
| WMAN | Wireless Metropolitan Area |
| | Network |
| WPANWireless | Personal Area Network |
| X2-C | X2-Control plane |
| X2-U | X2-User plane |
| XML | extensible Markup Language |
| XRES | EXpected user RESponse |
| XOR | exclusive OR |
| ZC | Zadoff-Chu |
| ZP | Zero Power |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1. One or more non-transitory, computer-readable media (NTCRM) having instructions, stored thereon, that when executed by one or more processors, cause a user equipment (UE) to:
receive configuration information for a transmit beam cycling pattern to be used for transmission of an uplink signal with repetition; and
encode the uplink signal for transmission with repetition in accordance with the transmit beam cycling pattern.

2. The one or more NTCRM of claim 1, wherein the uplink signal is a physical uplink shared channel (PUSCH) or a physical uplink control channel (PUCCH).

3. The one or more NTCRM of claim 1, wherein, to encode the uplink signal for transmission with repetition, the UE is to:
apply a first transmit beam for a first set of one or more transmission occasions of the uplink signal; and
apply a second transmit beam for a second set of one or more transmission occasions of the uplink signal.

4. The one or more NTCRM of claim 3, wherein, to encode the uplink signal for transmission with repetition, the UE is further to repeat the transmit beam cycling pattern for subsequent transmission occasions of the uplink signal.

5. The one or more NTCRM of claim 3, wherein the first and second sets of one or more transmission occasions each include one transmission occasion.

6. The one or more NTCRM of claim 3, wherein the first and second sets of one or more transmission occasions each include multiple transmission occasions.

7. The one or more NTCRM of claim 3,
wherein the configuration information indicates a number of the one or more transmission occasions included in the respective first and second sets; or
wherein the number of the one or more transmission occasions included in the respective first and second sets is predefined; or
wherein the instructions, when executed, are further to cause the UE to determine the number of transmission occasions included in the respective first and second sets based on a number of repetitions of the uplink signal; or
wherein the number of transmission occasions included in the respective first and second sets corresponds to a number of uplink transmission occasions in which a same frequency resource is allocated for uplink transmission.

8. The one or more NTCRM of claim 1, wherein to encode the uplink signal for transmission with repetition, the UE is to apply a first transmit beam for a first part of an uplink signal transmission occasion, and apply a second transmit beam for a second part of the uplink signal transmission occasion.

9. The one or more NTCRM of claim 1, wherein the instructions, when executed, are further to cause the UE to receive a downlink control information (DCI) to schedule the transmission of the uplink signal in accordance with the transmit beam cycling pattern.

10. The one or more NTCRM of claim 9, wherein the DCI includes an SRS resource indicator to indicate multiple transmit beams to be used for the transmission of the uplink signal.

11. One or more non-transitory, computer-readable media (NTCRM) having instructions, stored thereon, that when executed by one or more processors cause a next generation Node B (gNB) to:
encode, for transmission to a user equipment (UE), configuration information for a transmit beam cycling pattern to be used for transmission of an uplink signal with repetition; and
receive, from the UE based on the transmit beam cycling pattern, a first set of one or more transmission occasions of the uplink signal using a first receive beam; and
receive, from the UE based on the transmit beam cycling pattern, a second set of one or more transmission occasions of the uplink signal using a second receive beam.

12. The one or more NTCRM of claim 11, wherein the uplink signal is a physical uplink shared channel (PUSCH) or a physical uplink control channel (PUCCH).

13. The one or more NTCRM of claim 11, wherein the instructions, when executed are further to cause the gNB to repeat the transmit beam cycling pattern to receive additional transmission occasions of the uplink signal.

14. The one or more NTCRM of claim 11, wherein the first and second sets of one or more transmission occasions each include multiple transmission occasions.

15. The one or more NTCRM of claim 11, wherein the configuration information indicates a number of the one or more transmission occasions in the respective first and second sets.

16. The one or more NTCRM of claim 11, wherein the configuration information includes a physical uplink control channel (PUCCH) spatial relation information element to configure multiple reference signals for respective transmit beams of the transmit beam cycling pattern.

17. An apparatus to be implemented in a user equipment (UE), the apparatus comprising:
a memory to store configuration information for a transmit beam cycling pattern to be used for transmission of a physical uplink control channel (PUCCH) with repetition; and
processing circuitry coupled to the memory, the processing circuitry to:
encode, in accordance with the transmit beam cycling pattern, a first set of one or more PUCCH repetitions or transmission using a first transmit beam; and
encode, in accordance with the transmit beam cycling pattern, a second set of one or more PUCCH repetitions or transmission using a second transmit beam.

18. The apparatus of claim 17, wherein the processing circuitry is to repeat the transmit beam cycling pattern for subsequent transmission occasions of the uplink signal.

19. The apparatus of claim 17, wherein the first and second sets of one or more transmission occasions each include multiple transmission occasions.

20. The apparatus of claim 17, wherein the configuration information includes a physical uplink control channel (PUCCH) spatial relation information element to configure respective reference signals for the first and second transmit beam.
